(19) United States
(12) Patent Application Publication
(10) Pub. No.: US 2019/0102752 A1
(43) Pub. Date: Apr. 4, 2019

(54) SYSTEM AND METHOD OF EVALUATING A COMMERCIAL GOOD PRIOR TO BEING PLACED IN COMMERCE

(71) Applicants: Philip Valenti, Coral Springs, FL (US); Brett Levee, Coral Springs, FL (US)

(72) Inventors: Philip Valenti, Coral Springs, FL (US); Brett Levee, Coral Springs, FL (US)

(21) Appl. No.: 16/146,427

(22) Filed: Sep. 28, 2018

Related U.S. Application Data
(60) Provisional application No. 62/565,623, filed on Sep. 29, 2017.

(51) Int. Cl. G06Q 10/00; G06Q 30/06; G07C 5/08

(52) U.S. Cl. CPC G06Q 10/20; G07C 5/0841; G07C 5/0808; G06Q 30/0627

(57) ABSTRACT

A system and methods of inspection, documentation, reporting, and rating of a commercial good, such as a vehicle, prior to placing the commercial good into commerce.

In accordance with 37 C.F.R. 1.76, a claim of priority is included in an Application Data Sheet filed concurrently herewith. Accordingly, the present invention claims priority to U.S. Provisional Patent Application No. 62/565,623, entitled “SYSTEM AND METHOD OF EVALUATING A COMMERCIAL GOOD PRIOR TO BEING PLACED IN COMMERCE”, filed Sep. 29, 2017. The content of the above referenced application is incorporated herein by reference in its entirety.

### FIELD OF THE INVENTION

The present invention relates to a system and methods for providing users information relating to commercial goods; to a system and methods for providing users information relating to a vehicle; for a system and methods for electronic documentation of the status of a vehicle prior to selling the vehicle; and more particularly, to a system and methods of inspection, documentation, reporting, and rating of a vehicle, such as an automobile, prior to placing the vehicle into commerce.

### BACKGROUND OF THE INVENTION

With over 1 billion vehicles estimated to be driving on roads worldwide, automobiles play an essential part of the global economy. New vehicle sales in 2016 are estimated to have been approximately 90 million units. The sale of used vehicles has been vigorous as well. In the United States alone, where the used vehicle market is robust, it is estimated that 40 million used vehicles are sold each year. In fact, 3 out of every 4 vehicles sold in the U.S. are used vehicles. While not the only outlet for vehicle sales, automobile dealerships tend to be one of the main outlets for vehicle transactions. Efficiently running a vehicle dealership can be a complex operation, with such operation trying to maximize vehicle inventory on hand to meet changing consumer demands, but not having too much supply in order to minimize such associated costs. In addition, the nature of vehicle sales often involves consumers trading their current vehicle for a newly purchased dealer vehicle. This transaction can be problematic for the dealership, as some trade-in vehicles are not vehicles the dealership may want to, or can, resell. As such, auto dealerships need a mechanism to buy and sell vehicles to increase or decrease their inventory as required.

Remarketing, the selling of vehicles wholesale at auctions sites or online, or by selling them directly to other dealers, is an essential component of vehicle transactions. The remarketing and auction industry is designed to support auto dealerships, financial institutions, manufacturers (OEMs), rental car companies, fleet management companies, leasing companies, and other wholesale and retail vehicle consignors and remarketers in selling their vehicles for maximum return. Accordingly, systems and products are designed to assist these stakeholders throughout the process, with the idea of improving efficiency and minimizing the time sellers and auctions spend managing their inventory. With approximately 9-10 million vehicles sold at auction each year, wholesale auctions are designed to maximize the vehicle sales by efficiently, quickly, and accurately moving vehicles through the process. Much of the selling process is performed prior to the actual sale date. As such, many auction sites strive to support wholesale consignors by identifying inventory, providing mechanical and cosmetic inspections and services, and reconditioning and transportation services.

Condition reports provide sellers and buyers with a formal document describing the condition of the vehicle being sold. These documents have been found to be very important in the remarketing process as auto dealers are more likely to place a bid on a vehicle at auction for which a condition report was generated. More importantly, auto dealers are more likely to purchase a vehicle with a condition report. While the general idea of the condition report is universal, i.e., the document provides information relating to one or more characteristics of the vehicle, actual condition reports, whether the final end product generated or how the report is generated, can vary significantly within the industry.

Given the increased likelihood of a vehicle sale attached to the use of a condition report, generation of such a report must be performed efficiently, quickly, and accurately. Because there are many different vehicle types, makes and models with varying trimlines and equipment, it is impossible for any one inspector or dealership to know every product comprehensively. Regardless of the vehicle type, year, make, model, trimline, equipment or many other vehicle attributes, it is essential for the inspector preparing the condition report to be able to perform a condition report quickly, accurately and efficiently.

In addition, because buying a vehicle is one of the largest investments most consumers undertake, online retail transactions tend not to be utilized. However, as the frequency of online sales continues to rise and consumers are more accustom to such a purchasing method, it is not unreasonable to see the retail dealership model move significantly toward online transactions. Moreover, due to the internet and the information age, consumers have increasingly become more knowledgeable in nearly every industry. The auto market may be no exception. Dealers purchase vehicles wholesale utilizing condition reports every day, and it is only a matter of time before consumers demand the same. Condition reports may in fact provide consumers with the confidence and trust needed to purchase a vehicle from the comfort of their living room without ever seeing their new vehicle beforehand. As this type of transaction scenario occurs and grows, dealerships will increasingly use tools like the condition report on potential trade-in vehicles for purchase valuation and wholesale remarketing, and their own retail vehicles for retail sale to the public. Accordingly, for a dealership to incorporate a condition report into their daily routine, the condition report process must enable a user to perform the inspection quickly, accurately and efficiently regardless of the vehicle type, year, make, model, trimline, specific vehicle characteristics and condition.

Therefore, there is a need in the wholesale and retail vehicle sales industry for a condition report application that is accurate, user friendly, and is generated quickly and efficiently.

### SUMMARY OF THE INVENTION

The present invention describes a system and methods of inspection, documentation, reporting, and rating of a commercial good, such as a vehicle, prior to placing the commercial good into commerce. While the specification describes the systems and methods for use prior to placing the commercial good into commerce, the systems and methods may also be used when the commercial good is in commerce as well.

The system and methods disclosed herein allow an inspector to electronically document the condition of a commercial good prior to the commercial good being sold. The electronic document may be in the form of a condition report which highlights one or more problem areas or damages of the commercial good. A condition report and its damage line item(s), or damage line item list and corresponding work order and other workflow processes, can be initiated and/or created by an inspector at one or more locations and received by a main server system. As used throughout this application, a vehicle is described and used as an illustrative example of a commercial good(s). The use of a system and methods for describing a vehicle is not meant as a limiting example. Accordingly, the main server may receive vehicle and vehicle owner information, including identification of the vehicle owner and detailed vehicle information, such as year, make, model, and VIN, from another server system. The main server has pre-defined seller business rules and vendor preferences and pricing information stored therein. Some of the pre-defined seller business rules and pricing information could be pre-loaded onto the system for operational, custom workflow and/or off-line use. The system and methods may be designed to utilize auto-generated damage line items, which can be programmed to provide communication, via task/flag lists, text messages, emails, chats, in-app notifications, or other forms of notifications, to the seller, auction house or third party vendors for work orders, estimate requests, transport/driver requests or other workflow. The system and method for generating a condition report is designed to be configurable by editing data input mechanisms that dynamically change the condition evaluator interface, workflow and/or the condition report document based on a commercial good, such as vehicle type, and/or vehicle options, by customer, seller, buyer, inspector or user specific business rules, or any other entity or entity type, or vehicle specific attributes, condition data or combinations thereof by only having to update, add and/or remove rows in a database table.

In an illustrative embodiment, a system for inspecting, documenting, reporting, or rating of a commercial good may comprise an electronic commercial goods report having one or more information components which document a condition of a commercial good; at least one electronic device having a screen for displaying images, a processor operable to execute instructions and a data storage medium for storing instructions, which, when executed by the processor, cause the processor to display the changeable electronic commercial goods report having one or more information components which documents a condition of a commercial good; and at least one data source operatively connected to the at least one electronic device.

In an illustrative embodiment, a method for inspecting, documenting, reporting, or rating of a commercial good may comprise using at least one electronic device for generating an electronic commercial goods condition report having one or more information components which documents a condition of a commercial good, the at least one electronic device having a screen for displaying images, a processor operable to execute instructions, and a data storage medium for storing instructions, which, when executed by said processor, cause the processor to display an electronic commercial goods report having information which documents a condition of the commercial good; and using at least one data source operatively connected to the at least one electronic device to provide data which forms at least a part of the electronic commercial goods condition report information.

In another embodiment, the present invention provides one or more non-transitory computer readable medium having computer readable instructions embodied thereon, wherein, when executed by at least one processor, the computer-executable instructions cause at least one processor to at least: display the changeable electronic commercial goods report having one or more information components which documents a condition of a commercial good; and at least one data source operatively connected to the at least one electronic device, or perform any function described herein. As used herein, the term “non-transitory computer readable medium” includes all computer readable media with the exception of a transitory, propagating signal.

Accordingly, it is an objective of the invention to teach a system for providing users information relating to goods to be sold in commerce.

It is a further objective of the invention to teach a system of inspection, documentation, reporting, and rating of goods prior to placing the goods into commerce.

It is a further objective of the invention to teach methods of inspection, documentation, reporting, and rating of goods prior to placing the goods into commerce.

It is a further objective of the invention to teach a system of inspection, documentation, reporting, and rating of a vehicle prior to placing the vehicle into commerce.

It is yet another objective of the invention to teach methods of inspection, documentation, reporting, and rating of a vehicle prior to placing the vehicle into commerce.

It is a further objective of the invention to teach systems and methods for providing users information relating to goods.

It is a further objective of the invention to teach methods for providing users information relating to a vehicle.

It is a further objective of the invention to teach a system for providing users information relating to a vehicle.

It is yet another objective of the invention to teach a system for electronic documentation of the status of a vehicle prior to selling the vehicle.

It is still a further objective of the invention to teach methods for electronic documentation of the status of a vehicle prior to selling the vehicle.

It is a further objective of the invention to teach a system of inspection, documentation, reporting, and rating of a vehicle prior to placing the vehicle into commerce.

It is yet another objective of the invention to teach methods of inspection, documentation, reporting, and rating of a vehicle prior to placing the vehicle into commerce.

It is still a further objective of the invention to provide a system and methods of inspection, documentation, reporting, and rating of a vehicle prior to placing the vehicle into commerce, which are configured to generate work orders, estimate requests and transport orders, optimize and automate decision making, schedule logistics and workflow processes online and in the physical world, and make optimized decision recommendations that remove bottlenecks that may impact the sale of the vehicle based on, but not limited to, the following: damage line items, vehicle type, any vehicle attribute, condition data, seller type or seller, or user specific business rules and objectives, other data, market data, machine learning, or combinations thereof, that may be determined during the inspection and creation of a condition report, or that has already been pre-determined prior to the inspection or received via data integration or VIN decoding.

Other objectives and advantages of this invention will become apparent from the following description taken in conjunction with any accompanying drawings, wherein are set forth, by way of illustration and example, certain embodiments of this invention. Any drawings contained herein constitute a part of this specification, include exemplary embodiments of the present invention and illustrate various objects and features thereof.

### BRIEF DESCRIPTION OF THE FIGURES

FIG. 1A is a schematic drawing illustrating the system and methods of inspection, documentation, reporting, and rating of goods prior to placing the goods into commerce;

FIG. 1B is a screen shot of the “Vehicle” Tab on the condition report interface with the main vehicle components;

FIG. 2 is a screen shot illustrating the “Options” components in the formation of the condition report;

FIG. 3A is a screen shot of an illustrative example of a damage line item list;

FIG. 3B is a screen shot of an alternative example of the damage line item list;

FIG. 3C is a screen shot showing the activation of menu button 230;

FIG. 3D is a screen shot of the exterior damage line item selector 169 after selecting the “Duplicate Damage” button illustrated in FIG. 3C;

FIG. 3E is an alternative save method screen shot after selecting the “Left Quarter Panel” illustrated in FIG. 3D;

FIG. 3F illustrates a screen shot once a user activates the “Duplicate Dmg for Multi-Parts” button;

FIG. 3G illustrates a screen shot once a user activates the “LF Fender”, the “LF Door”, and the “LR Door”;

FIG. 3H illustrates a screen shot once the user has selected various parts then presses the “Proceed” button;

FIG. 4A is an additional screen shot of the “Options” component;

FIG. 4B is a screen shot illustrating an alternative save method for the Damage Quick Add button;

FIG. 5 is a screen shot illustrating the “Tires” components in the formation of the condition report;

FIG. 6A is a screen shot of an illustrative embodiment of an interior damage quick assessment component that has single and multi-part Damage Quick Add Buttons;

FIG. 6B is a screen shot of an alternative save method for the Damage Quick Add button that allows for editing of pre-determined fields;

FIG. 7A is a screen shot of an illustrative embodiment of a work order;

FIG. 7B is a screen shot of an illustrative embodiment of a transport order;

FIG. 8 is a screen shot illustrating activation of two mechanical damage quick add components of the “Mechanical” tab relating to a vehicle's oil condition, and one relating to a vehicle's coolant condition being in good standing;

FIG. 9 is a screen shot illustrating activation of one component of the “Mechanical” tab relating to a vehicle's engine status;

FIG. 10A is a screen shot of an illustrative embodiment of an estimate request;

FIG. 10B is a screen shot of another illustrative embodiment of a transport order;

FIGS. 11A-11F provide screen shots of the “Damages” tab and the flow of the Exterior Damage Line Item Selector and the Multi-Part, Similar Damage Line Item mode of the Exterior Damage Line Item Selector;

FIG. 11G provides a screen shot of the “Damages” tab and the Interior Damage Line Item Selector in Multi-Part, Similar Damage Line Item mode;

FIG. 12 is a screen shot of the “Disclosure” tab and the activation of a “Disclosure” or “Announcement” component;

FIG. 13 is a screen shot illustrating a checkpoint component feature on the “Checks” Tab;

FIG. 14A through 14B are additional screen shots of the “Checks” tab illustrating the “Check Oil Pressure” checkpoint and the “Clear Bluetooth” checkpoint.

FIG. 15 is a screen shot illustrating the embodiment of the paint coating thickness meter components and workflow, and the results from the paint meter on four body panels being transferred to the application via Bluetooth;

FIG. 16 is a screen shot illustrating the embodiment of the OBD2 (On-board Diagnostics) component displaying the results from an OBD2 scan transferred to the application via Bluetooth;

FIG. 17A illustrates a screen shot of the “Exterior Vehicle Image”;

FIG. 17B is a screen shot which appears after the user has selected the “Right Qtr Panel”, the “RR Door”, “RF Door” or the “RF Fender”;

FIG. 17C illustrates a screen shot which appears after the user has selected the “Proceed” button on FIG. 17B;

FIG. 17D is a screen shot which appears after the user has selected “Damage-Prey Repair”; and

FIG. 17E is a screen which appears after the user has selected “Severity-Substd Repair”.

FIG. 17F is a damage line item save screen which appears after the user has selected “Remedy-Wet Sand”.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated. In addition, while each figure may show one or more components of the invention, it is understood that the invention may be configured to include one, some, or all of the components or elements shown, or even described in other figures or parts of the description.

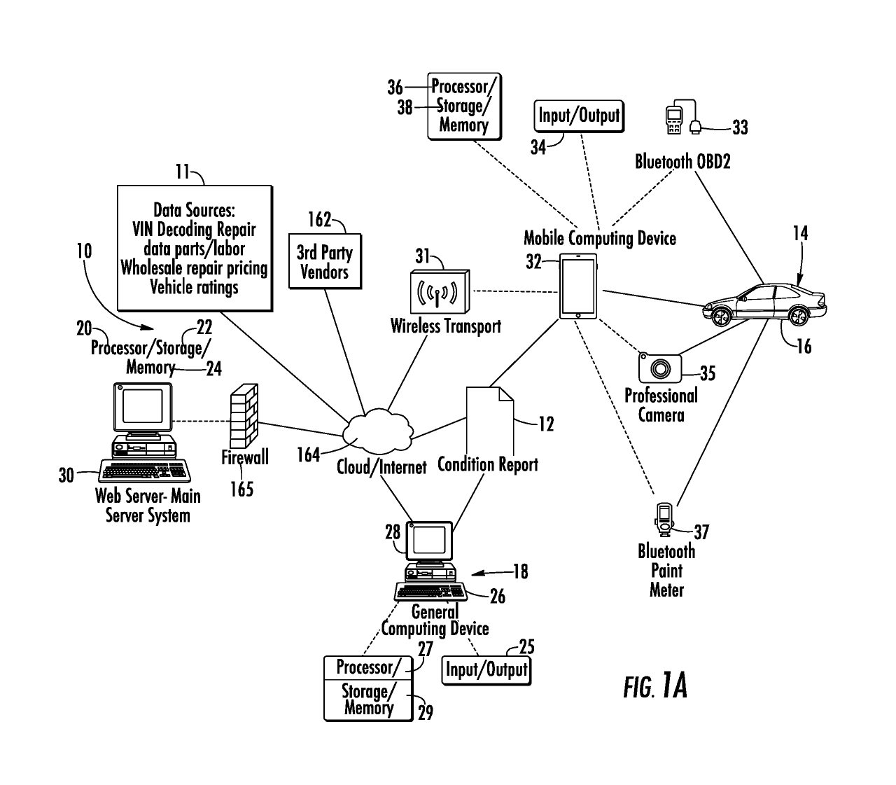

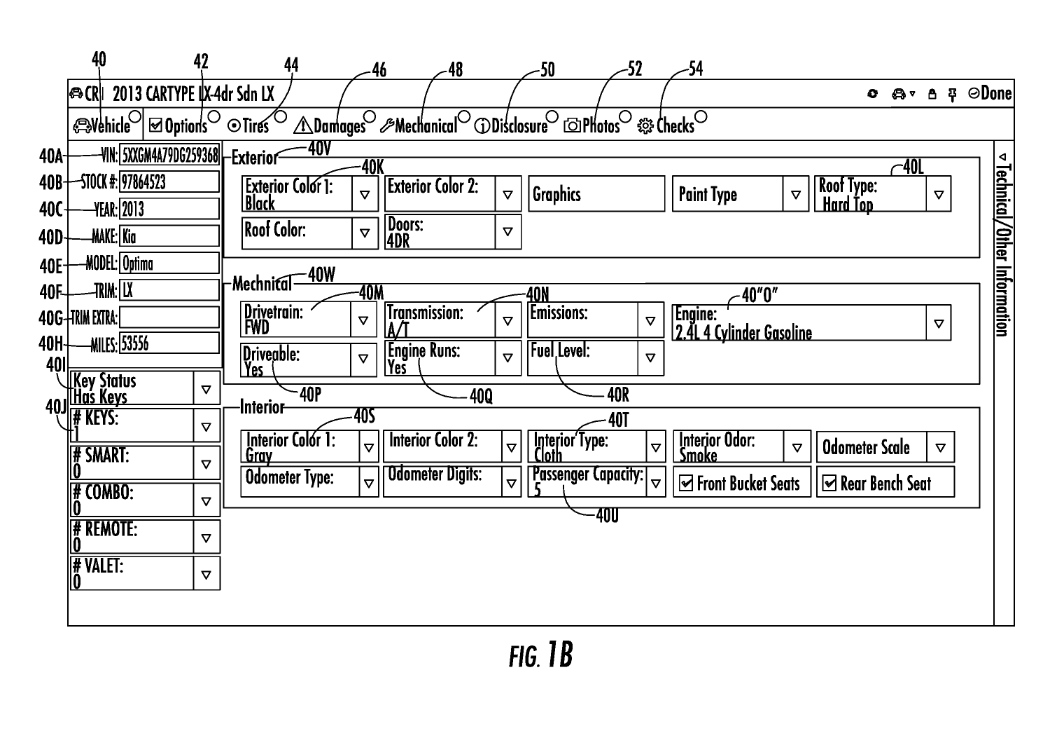

FIG. 1A is an illustrative example of a system for inspection, documentation, reporting, or rating of a commercial good(s) prior to placing the commercial good(s) into commerce, referred to generally as a commercial good(s) reporting system and methods 10. While the commercial good(s) embodied in the commercial goods reporting system and methods 10 is described as a used vehicle, particularly an automobile, or any other good(s) that requires inspection, documentation, reporting, or rating may be used. Types of vehicles may include a truck, van, bus, sport utility vehicle (SUV), minivan, station wagon, sedan, coupe, convertible, sports car, racecar, tractor, trailer, aircraft, such as an airplane or helicopter, or watercraft, such as a boat or ship. The commercial goods reporting system and methods 10 is configured to provide a data report 12, for a commercial good 14. As shown in FIG. 1, the commercial good 14 is shown as a vehicle 16 for which a data report 12, referred to as a vehicle condition report 12, is generated. The vehicle condition report 12 is provided as an electronically developed report that documents and may provide a rating as a result of the inspection process associated with and undertaken for the vehicle 16.

As illustrated in FIG. 1A, the commercial goods reporting system and methods 10 may contain a Web Server/Main Server System 30 having a processor 20 for implementing executable code, data storage 22, having executable code, and memory 24. The Web Server/Main Server System 30 will handle data synchronization with other electronic devices utilized within the commercial goods reporting system and methods 10. A mobile computing device 32, such as a computer tablet, a phone, such as a smart phone (mobile personal computer with a mobile operating system with features useful for mobile or handheld use; smart phones typically have the ability to place and receive voice/video calls and create and receive text messages, have a note-taking application, an event calendar, a media player, video games, GPS navigation, a digital camera and video camera; smart phones are designed to access the Internet through cellular frequencies or Wi-Fi (Wireless Transport) 31, and can run a variety of third-party software components, such as “apps”; they typically have a color display with a graphical user interface that covers the front surface, the display may be a touchscreen that enables the user to use a virtual keyboard to type words, numbers, and other characters, and press onscreen icons to activate “app” features), electronic glasses, a virtual reality device (device with computer technology that uses headsets to generate realistic images, sounds, and other sensations that simulate a user's physical presence in a virtual or imaginary environment), or other mobile computing device may also be used in the commercial goods reporting system and methods 10 as a mechanism to inspect the vehicle.

The mobile computing device 32 has an output display 34, a central processor 36 and storage and/or memory 38. A general computing device 18 with a display 28, processor(s) 27, storage and/or memory 29 and an input device 25, such as a keyboard 26 can be used in the commercial goods reporting system and methods 10 as a mechanism to input and retrieve data from the Web Server/Main Server System 30. The mobile computing device 32, general computing device 18, or Web Server/Main Server System 30 have the necessary hardware for processing capability, storage capability, and any necessary software to drive or control the functioning of various components, and may include, for example, logic boards such as printed circuit boards with the necessary integrated circuitry, central processing units, RAM, ROM, and/or hard drives. The mobile computing device 32 can integrate via Bluetooth, or other connectivity, with multiple other inspection devices to assist in generating the condition report 12, including, but not limited to, an OBD2 device (On-board Diagnostics) 33, a professional camera 35 and a paint meter 37. As displayed in FIG. 1A, the commercial goods reporting system and methods 10 may integrate with multiple data sources 11 including, but not limited to, VIN decoding data, repair data for parts and labor estimating, wholesale, aftermarket and used parts repair data pricing, and vehicle rating data.

While the use of the general computing device 18, Web Server/Main Server System 30, or smart phone is described throughout the specification to illustrate one or all components of the present invention, such embodiments are used for illustrative purposes, and other electronic devices, such as tablet computers, computers, or any other electronic devices having at least a processor operable to execute instructions and a data storage medium for storing instructions which, when executed by the processor, cause the processor to perform one or more functions, and/or a display screen for displaying an image, may be used or form part of the system.

In use, an inspector can use the general computing device 18 or the mobile computing device 32 to generate a report on the vehicle 16. As an illustrative example, a graphical user interface (GUI) can be used to guide the inspector in inspecting the vehicle 16 and in creating a vehicle condition report 12. As displayed in FIG. 1B, the vehicle condition report interface, comprised of the “Vehicle” Tab 40, the “Options” Tab 42, the “Tires” Tab 44, the “Damages” Tab 46, the “Mechanical” Tab 48, the “Disclosure” Tab 50, the “Photos” Tab 52, and the “Check Points” Tab 54, is a table configurable condition report in which the tabs, the groupings and individual reportable items are able to be configured for particular vehicles by including at least sellers, users, entity types, business rules, and any vehicle or condition attributes. This feature allows the software to generate a different condition report interface to an inspector based on desired configurations of a particular entity or user, or based on vehicle specific attributes, condition data, or combinations thereof. The inspector inspecting the vehicle 16 could also be a seller of the vehicle 16, and may need to produce different vehicle condition reports 12. By having a table configurable condition report interface, the inspector or inspecting company is not locked into a pre-defined style or workflow for every one of their various vehicles to sell. Moreover, having the ability to configure the vehicle condition report interface provides the inspection company, auction or seller with a vehicle condition report interface that can be used with a large number of customers without changing the code.

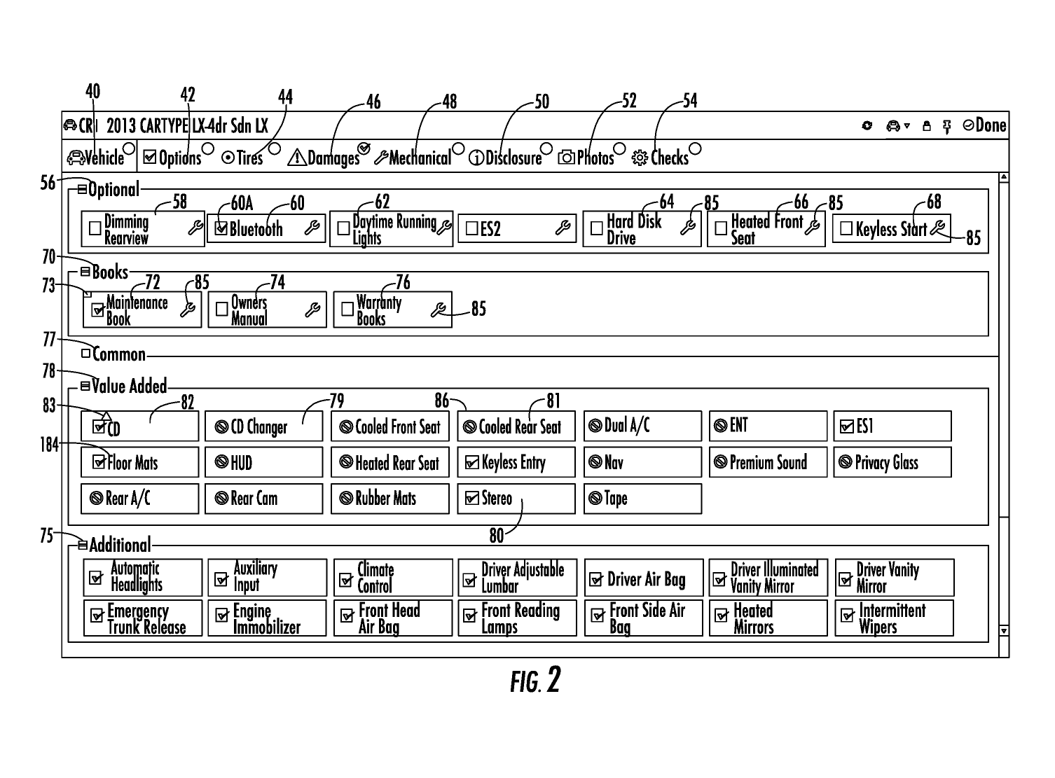

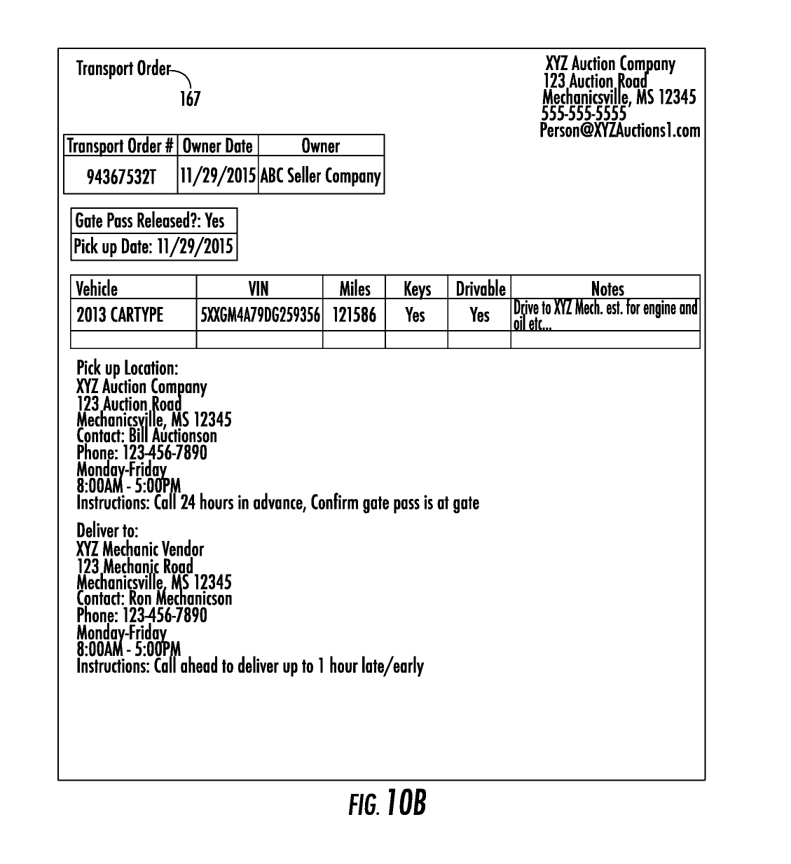

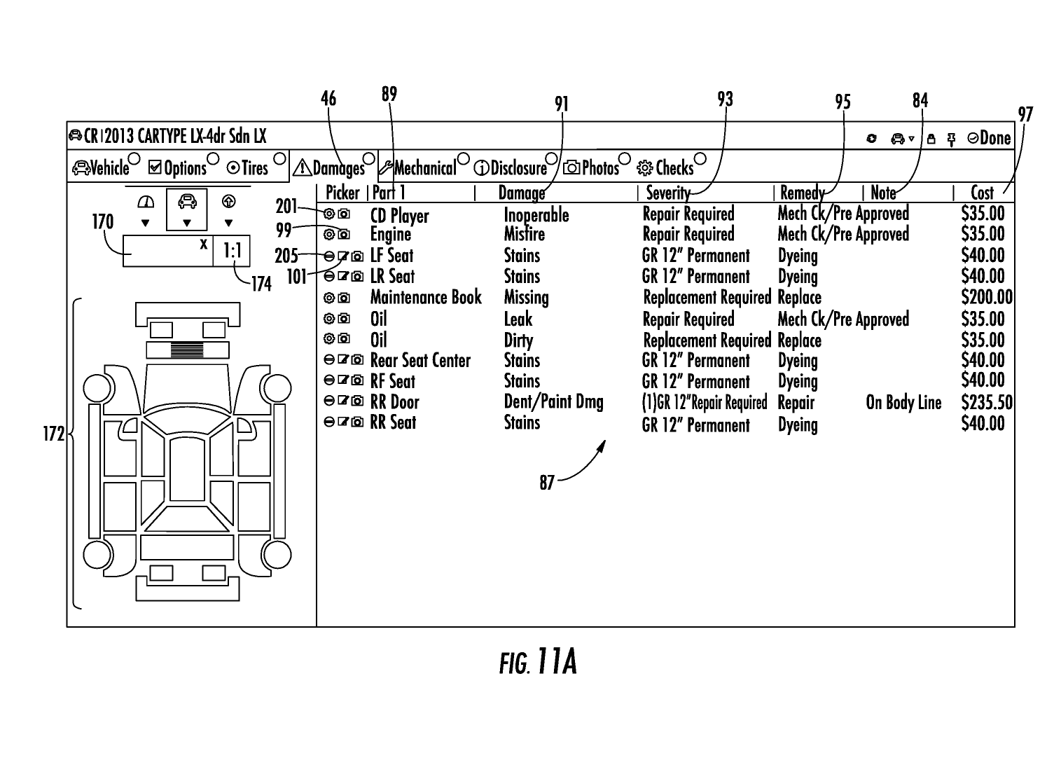

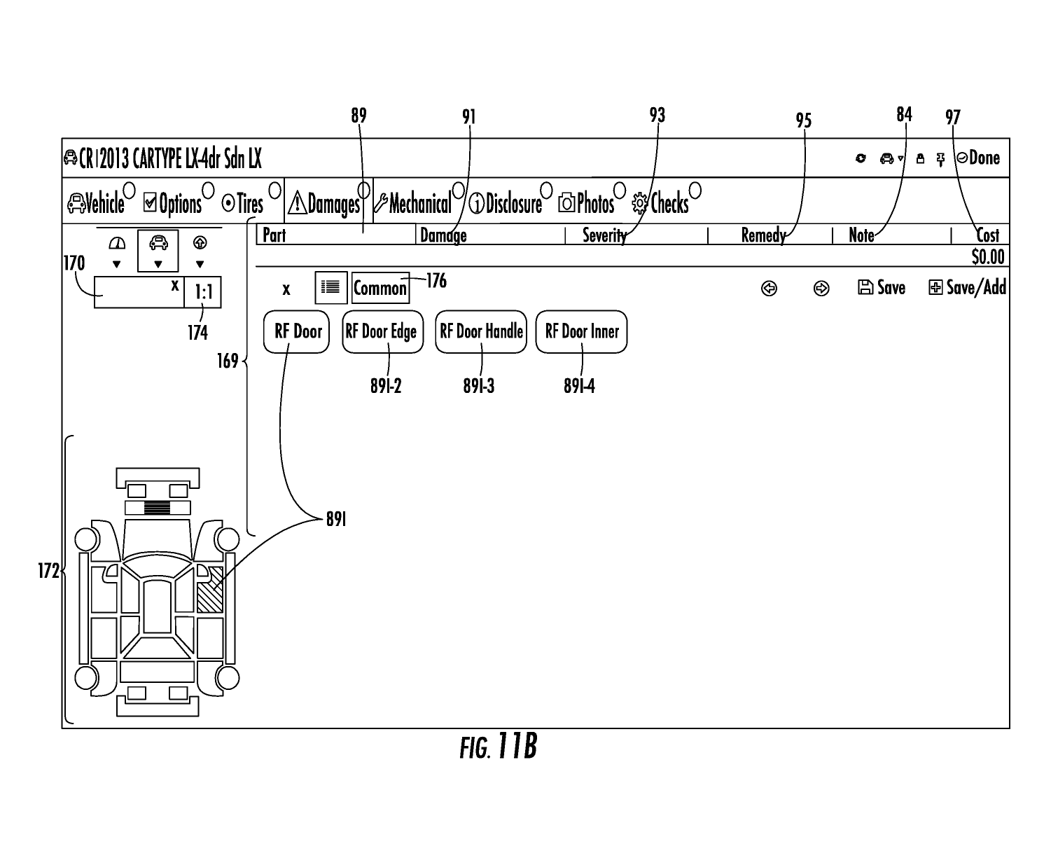

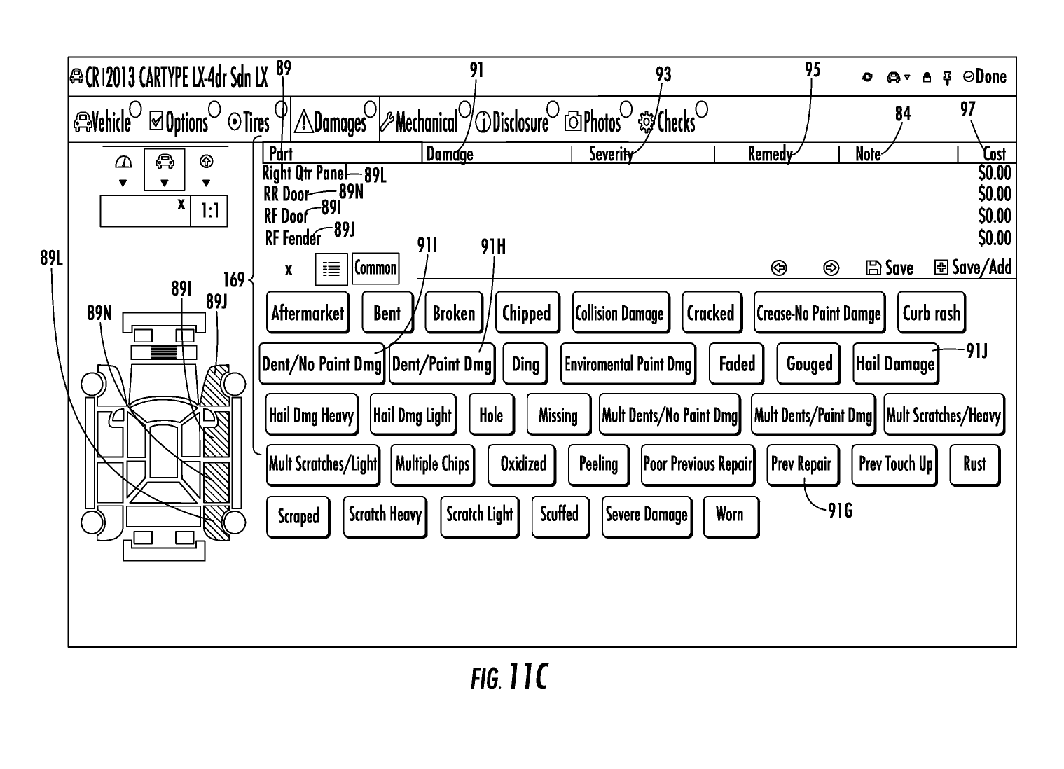

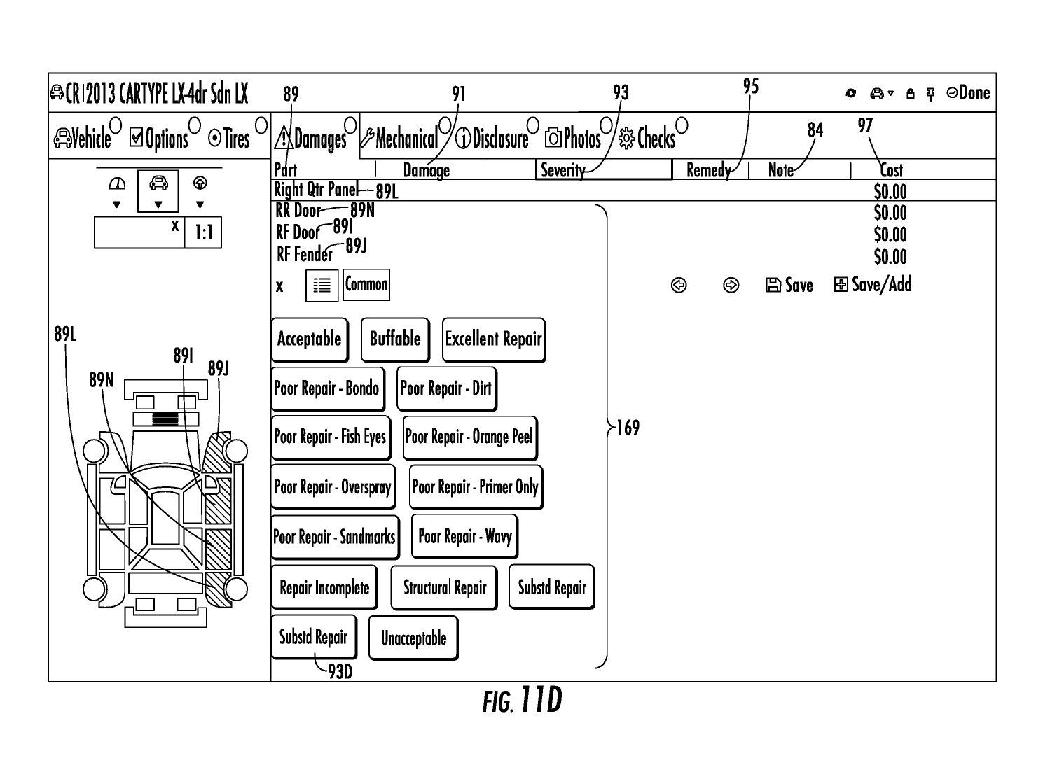

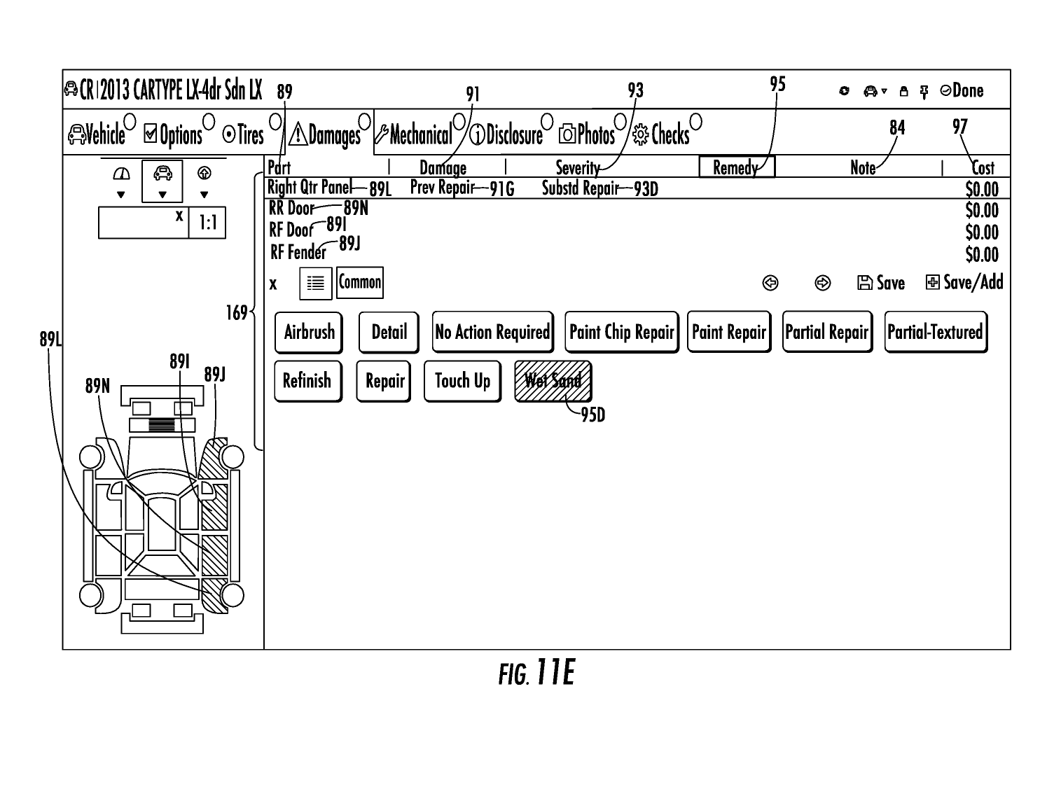

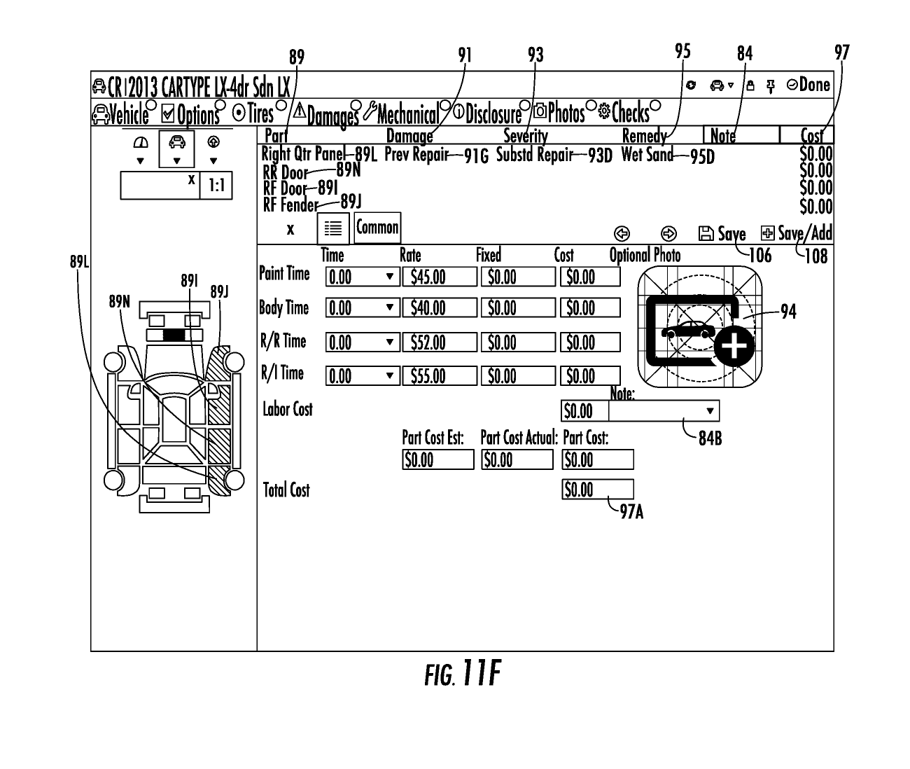

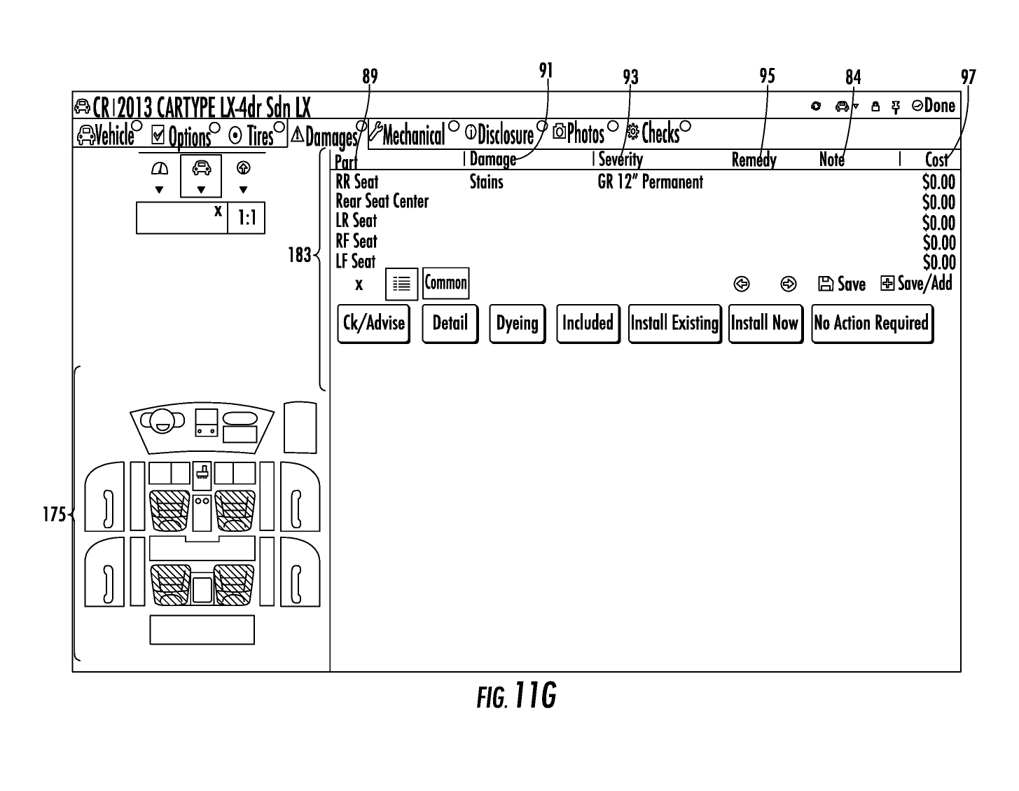

FIGS. 1A through 17F illustrate various screen shots or documents created which involved or created in the process of creating a vehicle condition report 12 using a variety of reportable conditions. As illustrated in FIG. 1A, the inspector can create a vehicle condition report 12 with information on multiple components of the vehicle 16 with a comprehensive set of tabs covering all areas of a vehicle. A “Vehicle” Tab 40, displayed in FIG. 2, allows the user to note the inclusion and/or condition of one or more of the main vehicle attributes of the interior, mechanical or exterior of a vehicle 16. The “Options Tab” 42 guides the user through any options that are currently contained in the vehicle and that were unknown to the VIN decoder. The “Tires” Tab 44 allows the inspector to notate the details and condition of the tires. The “Damages” Tab 46 allows the inspector to report on and document specific parts, by area of the vehicle, and generate damage line items to the options, equipment, accessories, interior, exterior, body, glass, trim, mechanical, wheels, tires, frame, unibody or structural components of the vehicle 16, such as a dent, scratch, rust, or any other damage to the vehicle 16, as well as the corresponding severity, remedy, notes, damage line item photos and repair estimates as displayed in FIGS. 11A-11G). As displayed on FIG. 11A, the “Damages” Tab 46 also enables the inspector to search for specific parts without specifically noting the area of the vehicle 16 using the “Search Box” 170. The “Mechanical” Tab 48 allows the inspector to notate the mechanical condition of the vehicle. The “Disclosure” Tab 50 allows the inspector to notate any disclosures. The “Photos” Tab 52 allows the inspector to view or provide a photo of any aspect of the vehicle 16, whether they are main photos, damage to the exterior, or the condition of the interior, such as the seats or other areas of the vehicle. Each of these tabs, the groupings, the fields, and the corresponding quick add damage line items can be dynamically configured uniquely or determined by editing rows in a table for the following, including, but not limited to, each user's or seller's business rules, seller type or by any vehicle type, condition data, any vehicle attribute or vehicle specific data, or combinations thereof.

FIG. 1B displays the Vehicle Tab 40 containing the main vehicle description fields and a few main condition fields including, but not limited to, “VIN” 40A, “Stock Number” 40B, “Year” 40C, “Make” 40D, “Model” 40E, “Trim” 40F, “Trim Extra” 40G, “Miles” 40H, “Key Status” 401, “Number of Keys” 40J, “Exterior Color” 40K, “Roof Type” 40L, “Drivetrain” 40M, “Transmission” 40N, “Engine” 40O, “Driveable” 40P, “Engine Runs” 40Q, “Fuel Level” 40R, “Interior Color” 40S, “Interior Type” 40T, and “Passenger Capacity” 40U. Some of these items are currently grouped by “Exterior” 40V, “Mechanical” 40W and “Interior” 40X. Most of these items have been decoded by a VIN decoder when the VIN was entered, either by typing it into the VIN field, sent via integration, or by scanning the VIN's barcode on the vehicle using a barcode scanner that utilizes the camera on the mobile computing device 32 that is integrated into the application.

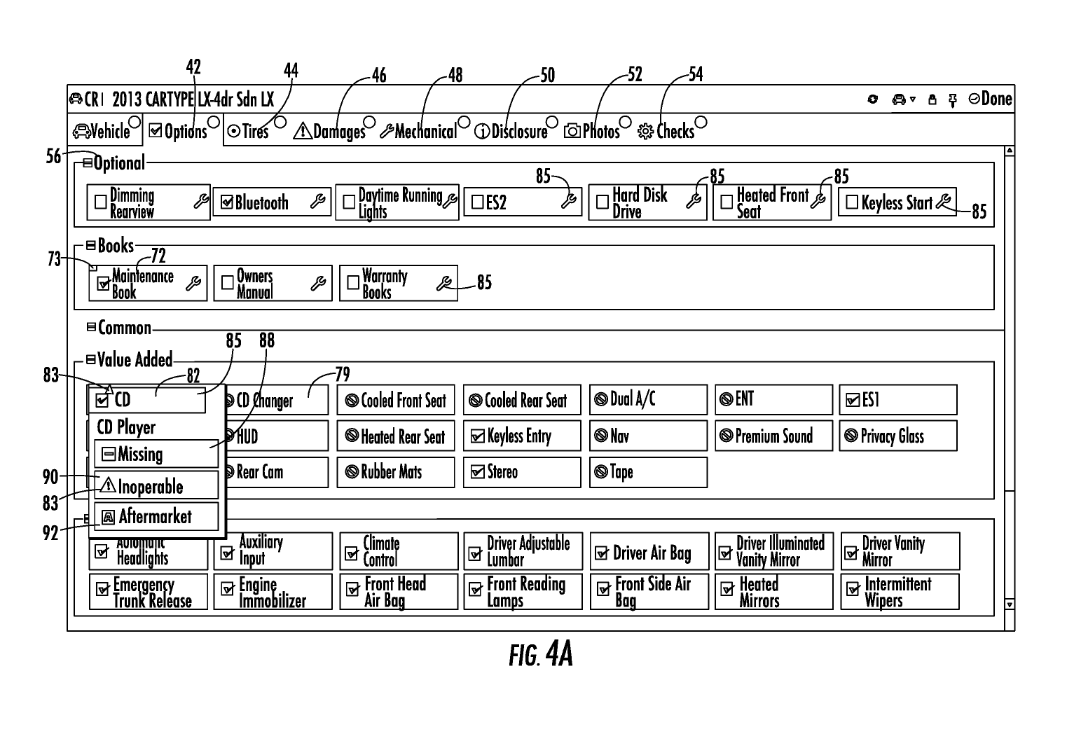

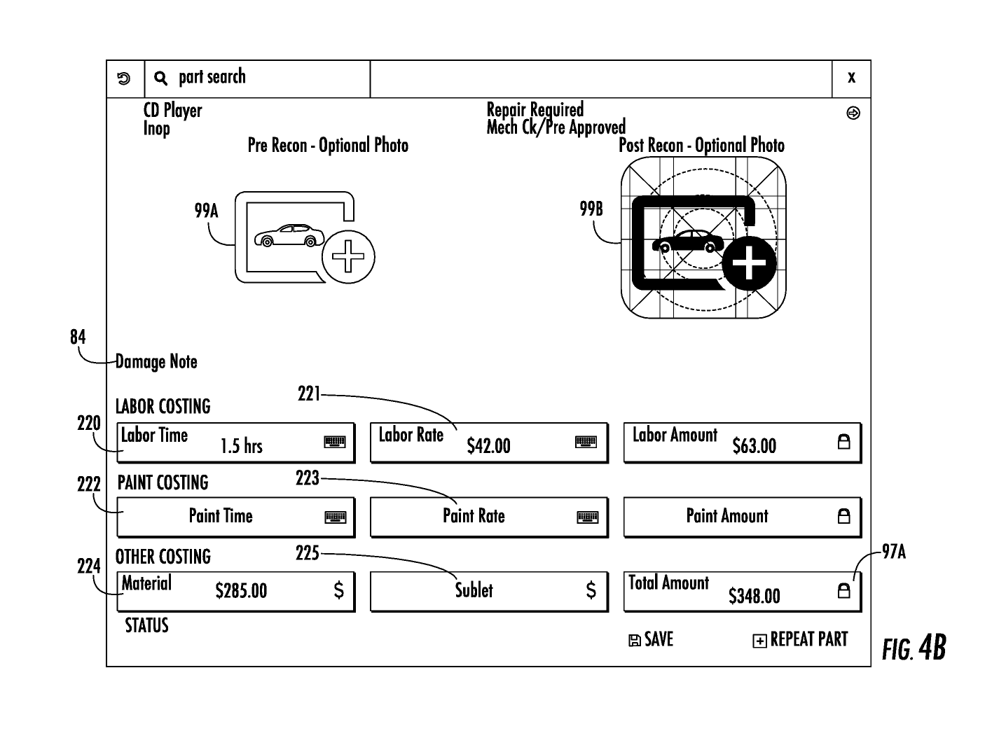

As displayed on FIGS. 2 and 4, in looking at the “Optional” group 56, the inspector is guided through the options that the VIN decoder provided as the manufacturer's “optional” equipment for this particular VIN, which may or may not have been installed on this vehicle. Each year, make and model, and their respective factory trim style, will have unique optional equipment items and/or packages. This particular vehicle has the following optional items: “Dimming Rearview” 58, “Bluetooth” 60, “Daytime Running Lights” 62, “Hard Disk Drive” 64, “Heated Front Seats” 66, or “Keyless Start” 68. The inspector has selected the “Bluetooth” option 60 as being installed on the vehicle, as signified by the “check mark” 60A. A “Books” grouping 70 allows the inspector to notate if the vehicle 16 has a “Maintenance Book” 72, an “Owner's Manual” 74, or a “Warranty Book” 76, or if any of them are missing. The “Common” group is detracted, as the options in this grouping are almost always installed. The “Common” group 77 will expand and display its options if any of the “Common” options were possibly not installed on the vehicle, per the VIN decoder. The “Value Added” group 78 allows the inspector to note which common “Value Added” and other semi-common features have been added to the vehicle, including whether or not there is a “Stereo” 80, “Floor Mats” 184, “CD” 82, or other options. The “Additional” grouping 75 contains all of the additional features that came standard on the vehicle that are not already a part of one of the other groupings. The features that the VIN decoder determined to be unavailable for this particular vehicle are grayed out and have the “NO symbol” 86, represented as a circle with the line through it, on the left side, see for example, “CD Changer” 79 or “Cooled Rear Seat” 81. The unavailable options could just as easily be completely hidden on the interface. The groupings and the options are displayed on the interface dynamically. Configurations can be made by simply adding, editing or removing rows in the database in order to dynamically add, edit or remove options, from the groupings and the quick add damage line items available to each option and/or grouping. These configurations can all be configured uniquely or determined by editing rows in a table for the following, including, but not limited to, each user's or seller's business rules, seller type, or by any vehicle type, condition data, any vehicle attribute or vehicle specific data, or combinations thereof.

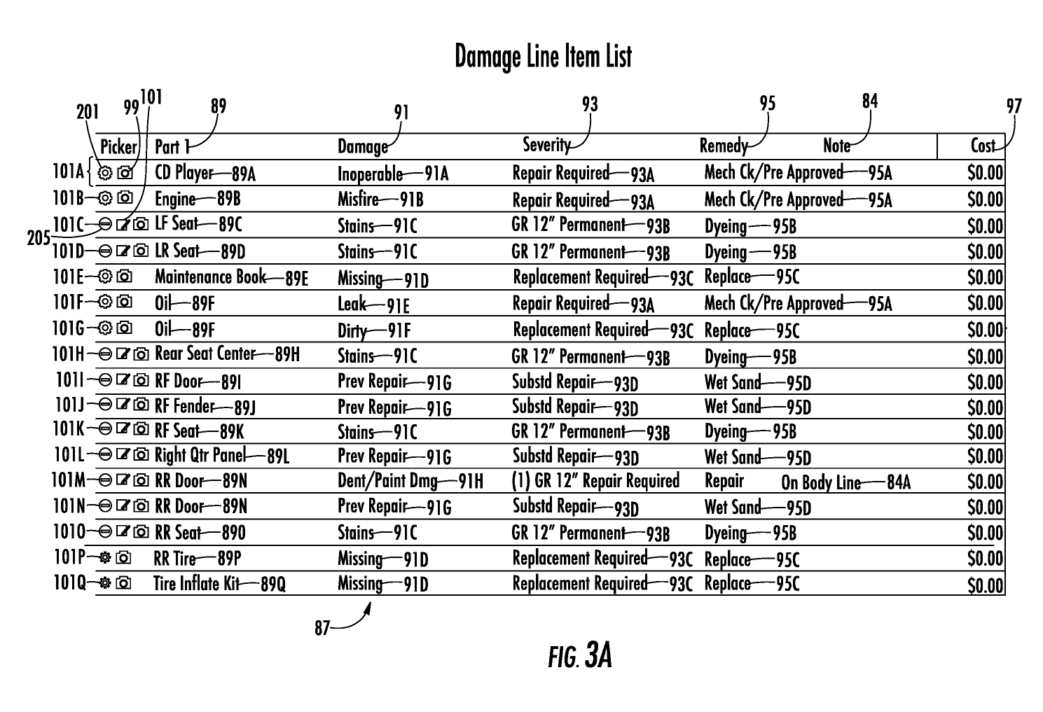

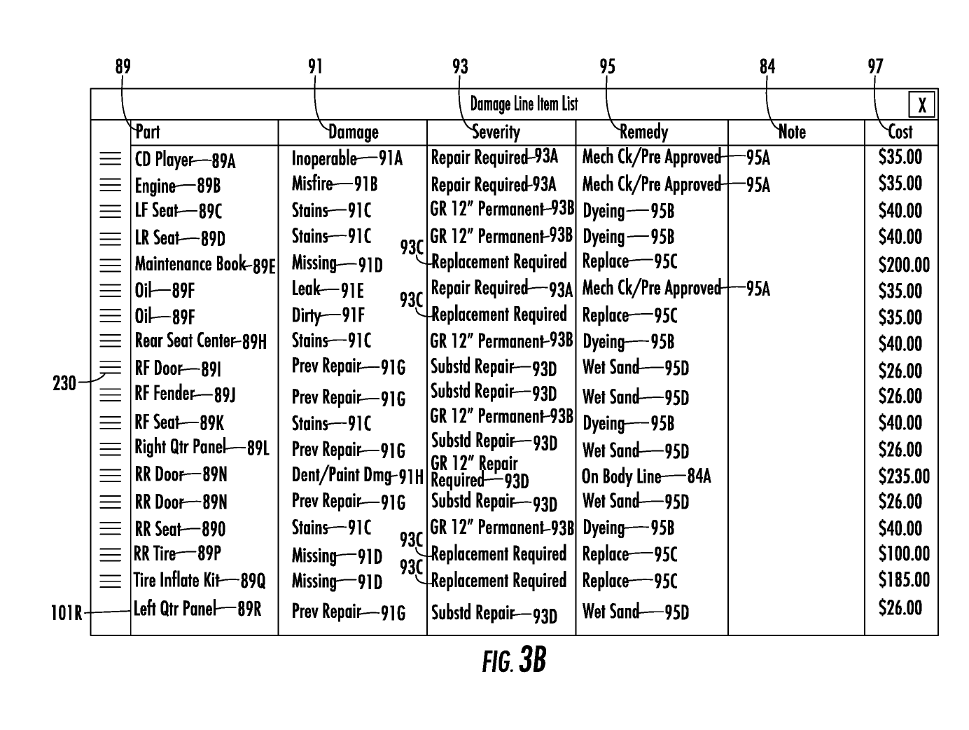

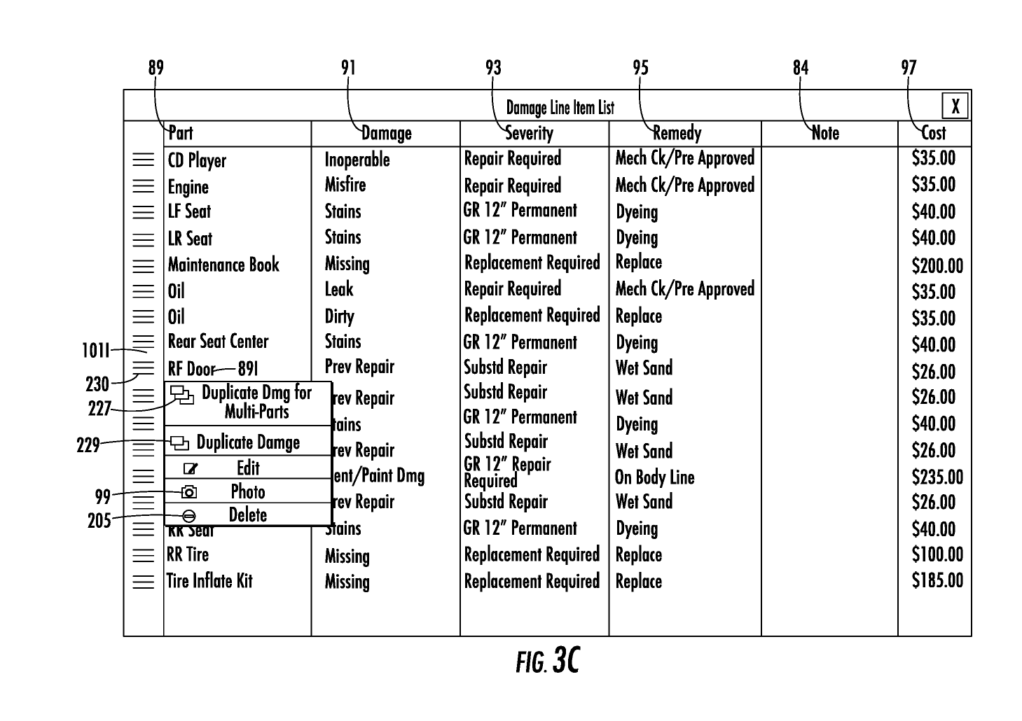

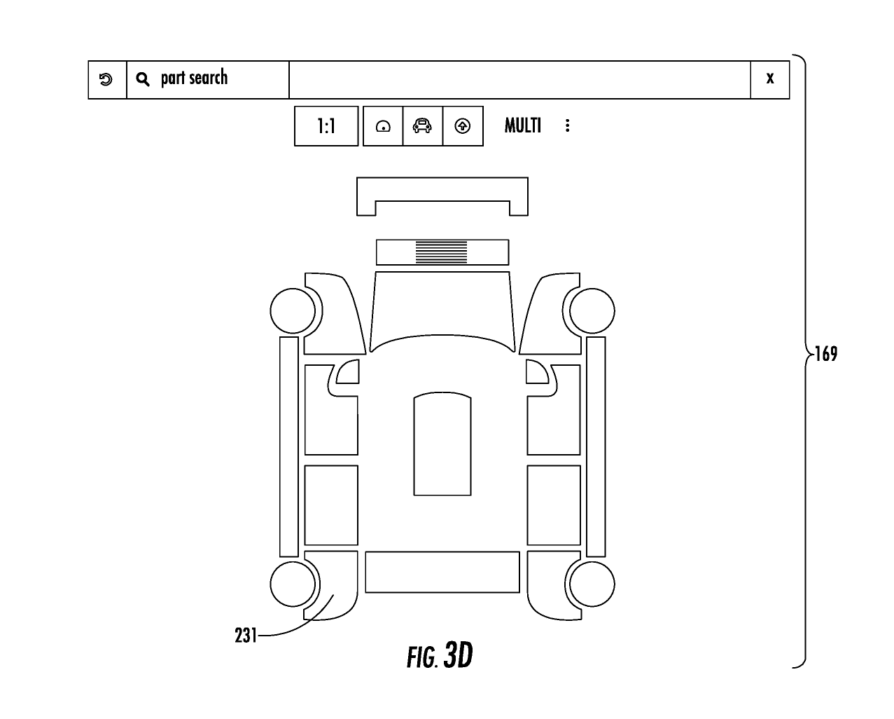

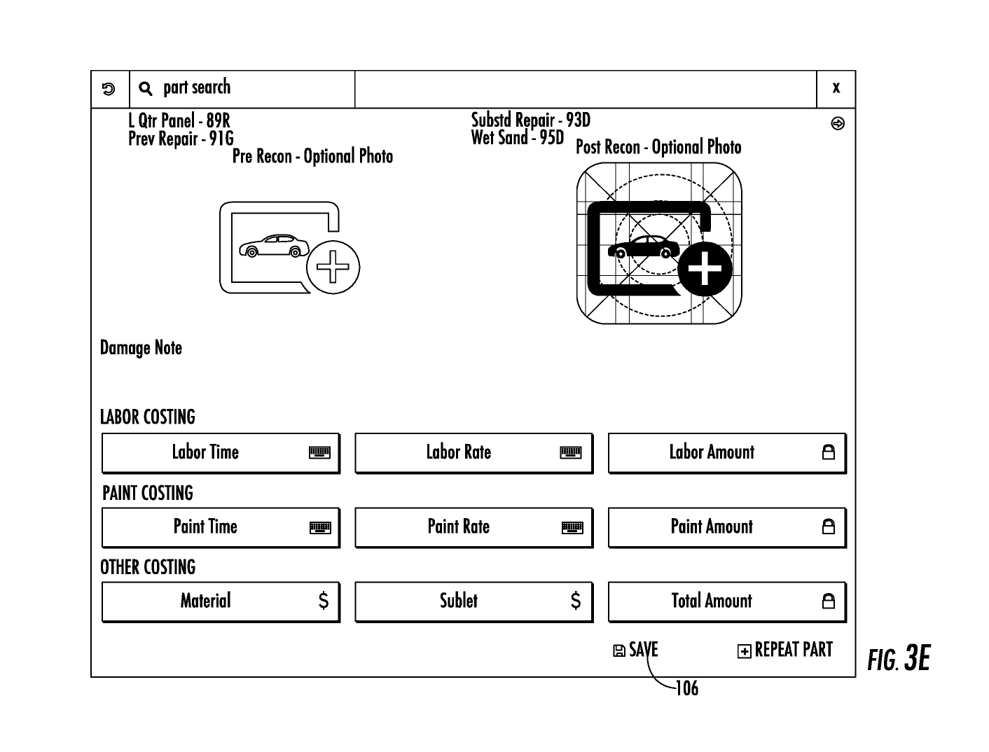

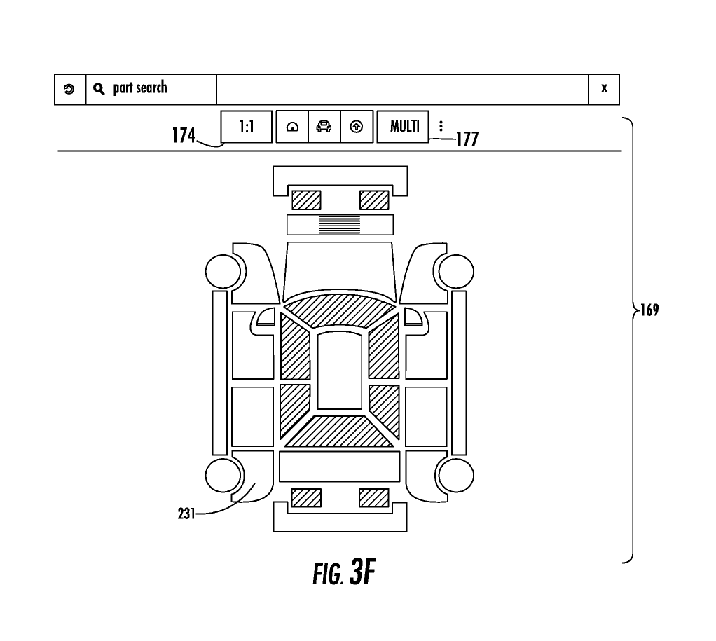

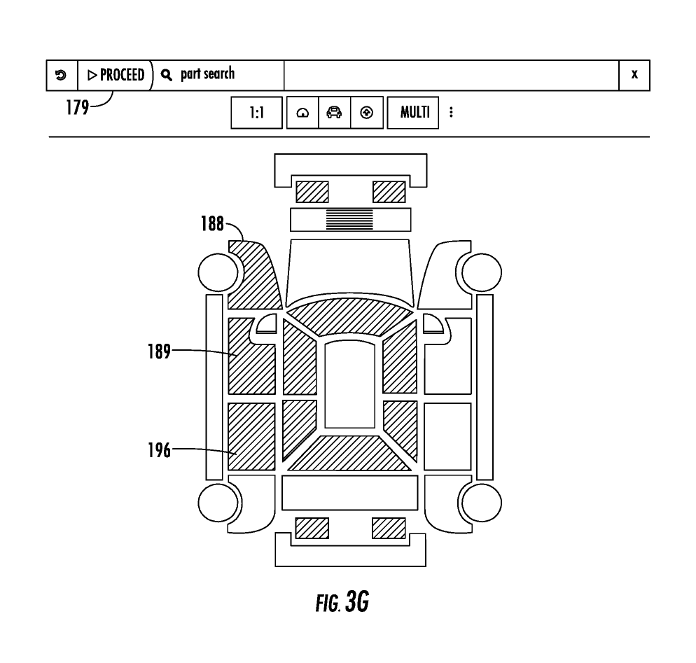

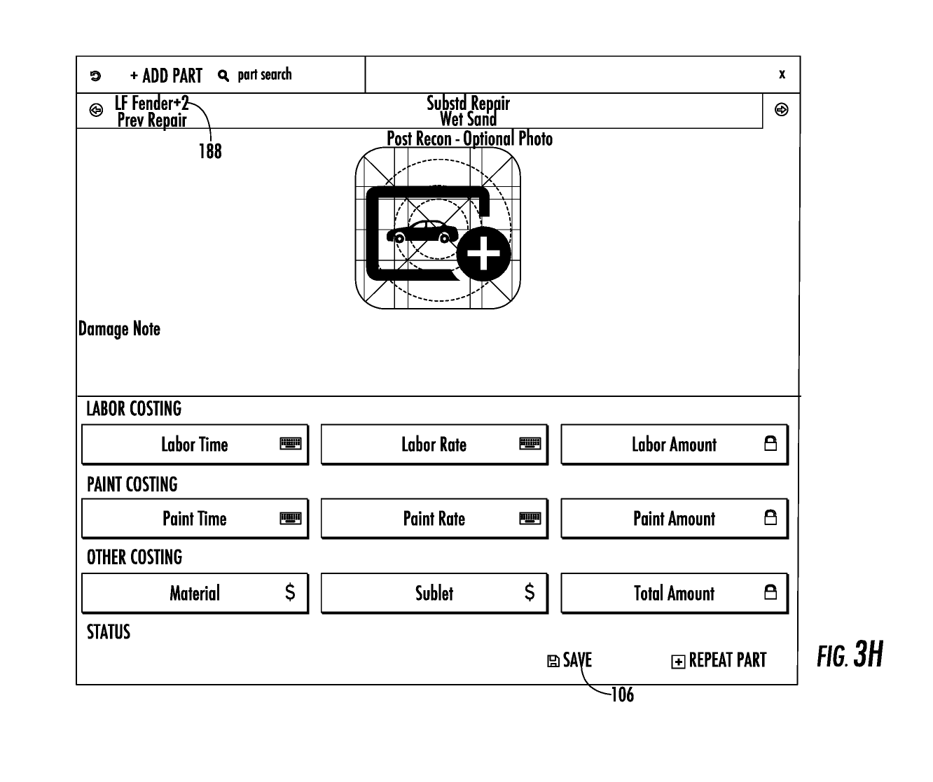

Almost all condition reports define valid combinations for vehicle damage exception line items; see for example, FIG. 3A or 3B, Damage Line Item List 87. The Damage Line Item List 87 may include a list of damage line items. Each damage line item may include a “Part” 89, a “Damage” 91, a “Severity” 93 that may contain the size, quantity and/or a qualitative severity, a “Remedy” 95, a “Note” 84 and an auto-generated or user entered “Cost” 97. The various parts that have damages on this particular vehicle are the “CD Player” 89A, “Engine” 89B, “Left Front Seat” 89C, “Right Front Seat” 89K, “Left Rear Seat” 89D, “Right Rear Seat” 89O, “Rear Center Seat” 89H, “Maintenance Book” 89E, “Oil” 89F, “Right Front Door” 89I, “Right Front Fender” 89J, “Right Quarter Panel” 89L, and “Right Rear Door” 89N. The “Damage” column 91 describes the type of damage associated with the various parts on this vehicle, including “Inoperable” 91A, “Misfire” 91B, “Stains” 91C, “Missing” 91D, “Leak” 91E, “Dirty” 91F, “Previous Repair” 91G, “Dent/Paint Damage” 91H. The “Severity” column 93 describes the severity of the damage, such as “Repair Required” 93A, “GR 12” Permanent” 93B, “Replacement Required” 93C, “Substandard Repair” 93D”. The “Remedy” column 95 describes what action needs to be taken to fix the item, such as “Mechanic Check/Pre-Approval” 95A, where a mechanic is required to review and provide diagnostics, “Dyeing” 95B, “Replace” 95C, or other actions, such as “Wet Sanding” 95D. A “Note” 84 may also be included (providing additional detail to the damage line item, such as “On Body Line” 84A (see damage line item 101M on FIG. 3A). Repair cost estimate amounts may also be included in the “Cost” column 97, providing a cost value for such repairs, including costs for paint, body, mechanical or other labor costs and/or parts pricing. Many vehicles have similar damage line item combinations. The configuration of the Damage Line Item List 87 allows the inspection company and/or seller to define multiple exception collections, and then link a vehicle to the collection that should be used for a particular auction, inspection company, seller or vehicle type. It also allows for the renaming of the Part, Damage, Severity, Note or Remedy descriptions. Each collection can be configured to have unique requirements and configurations for each Part, Damage, Severity, Note, Remedy, or specific combinations of each damage line item including, but not limited to, requiring a photo or video 99 for a specified damage line item combination, updating a vehicle heat map image for a specified damage line item combination, allowing specified parts and/or damage line item combinations for specific vehicle type, requiring a damage line item note 84 for defined damage line item combinations, determining available note templates, and marking each as common for accessibility. These collections and the parts, damages, severities, remedies, and combinations thereof, are configured dynamically by only updating rows in a database for the following, including, but not limited to, each user's or seller's business rules, seller type or by any vehicle type, condition data, any vehicle attribute or vehicle specific data, or combinations thereof. The parts and labor repair estimates are often pre-determined and automated for common damages by including, but not limited to, seller, user, part, damage, severity and recommended remedy or action. Some damage line item estimates are generated in the background with data pre-determined by the inspection company, auction, buyer or seller, in conjunction with parts and labor estimating repair data provided by third party data integrations, whether over web services, FTP integration or data provided by the third party and uploaded directly to the main server system.

FIGS. 4A and 4B illustrate additional features for use in completing the vehicle condition report 12, and the first example of a Damage Quick Add Button. With regards to activating the “CD” 82 button, i.e. by clicking on the wrench icon 85, the user accesses the Damage Quick Add Button for “Inoperable” 90 and generates a full damage line item exception, with just the single click of a button. The damage examples provided in FIG. 4A are “Missing” 88, “Inoperable” 90, and “Aftermarket” 92. The Damage Quick Add Buttons will automate the “Severity” 93 and “Remedy” 95 to the default severity and remedy for each damage selected. In FIG. 4A, the “CD” button 82 has been activated to include one selection, “Inoperable” 90, automating a Damage Line Item 101A, see FIG. 3A, for “Part-CD Player” 89A; “Damage-Inoperable” 91A; “Severity-Repair Required” 93A; “Remedy-Mech Ck Pre-Approved” 95A. The selection “Damage-Missing” will generate a “Severity-Replacement Required” damage line item, and a “Remedy-Replace” or “Damage-Inoperable” will generate a “Severity-Repair Required” and a “Remedy-Mech Check Pre-Approved” damage line item. Any type of damage combination (i.e. “Damage” 91, “Severity” 93, “Remedy” 95) determined to be a commonly entered damage line item combination for each part can be made available to that part and inserted into to the interface dynamically by editing rows in a database table. Depending on the seller's business rules, the Remedy could have been “Remedy-Mech Check”. This allows the inspector to create a damage line item exception, such as on FIG. 3A-3B for any of these cases with just the press of a single button. The “CD Player” button 82 on FIG. 4A is also marked with a “Caution” icon 83, represented as a triangle with an exclamation mark in the center, to indicate a Quick Add exception has been applied for the “Part-CD Player” 89A and “Damage Inoperable” 91A visually on the component.

FIG. 4B displays an alternative save method for the Damage Quick Add button that allows for editing of the pre-determined fields, such as estimated “Labor Time” 220, “Labor Rate” 221, “Paint Time” 222, “Paint Rate” 223, “Material” 224 or “Sublet” 225 costs; editing any of the aforementioned fields will update the “Total Amount” field 97A. After pressing “Inoperable” 90 on FIG. 4A, instead of immediately saving the damage line item 101A on FIG. 3A-3B, the software configuration can allow the alternative save method page displayed in FIG. 4B to appear. From this page, a user may also add a “Damage Note” 84, take a pre-recon photo with the “Pre-Recon Photo” button 99A, take a post-recon photo with the “Post-Recon Photo” button 99B, suggest repairs or edit other fields related to the damage line item when necessary, and then press the “Save” button 106 (FIG. 4B) to save the auto-generated damage line item and any of the edited fields on FIG. 4B. When using the example in FIG. 4A and FIG. 4B together, the “CD” button 82 has been activated to include one selection, “Inoperable” 90, automating a Damage Line Item 101A, see FIG. 3A or 3B, for “Part-CD Player” 89A; “Damage-Inoperable” 91A; “Severity-Repair Required” 93A; “Remedy-Mech Ck Pre-Approved” 95A, and with the alternative save method in FIG. 4B, the user was allowed to edit estimated costs, enter a Damage Note, take damage line item photos, suggest repairs, and/or edit other fields related to the damage line item.

FIG. 4A also indicates that the “Maintenance Book” 72 has been marked with a “minus sign” icon 73 as missing, using a Quick Add button, automatically creating Damage Line Item 101E, see FIG. 3A or 3B, “Part-Maintenance Book” 89E; “Damage-Missing” 91D; “Severity-Replacement Required” 93C; “Remedy-Replace” 95C.

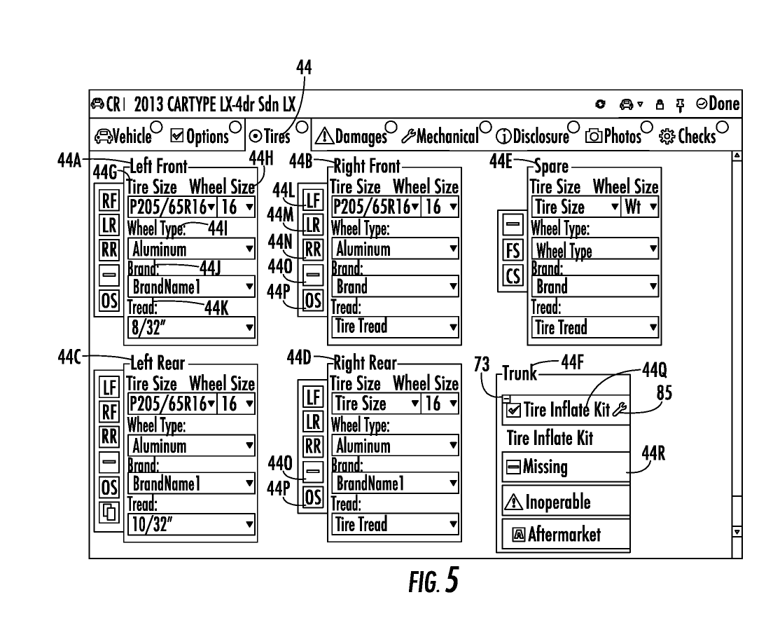

FIG. 5 illustrates the “Tires” tab 44 for use in completing the condition report 12, with additional examples of Damage Quick Add Buttons. The “Tires” tab 44 is currently displaying six groups of items, each with their own fields and/or Damage Quick Add Buttons: the “Left Front Tire/Wheel” 44A, the “Right Front Tire/Wheel” 44B, the “Left Rear Tire/Wheel” 44C, the “Right Rear Tire/Wheel” 44D, the “Spare Tire/Wheel” 44E, and items that are in the “Trunk” 44F. Each of the main tires/wheels has a “Tire Size” 44G, a “Wheel Size” 44H, a “Wheel Type” 441, a “Brand” 44J and “Tread” depth 44K. After entering or validating all of these fields on the “Left Front Wheel” 44A, the inspector could walk around to the “Right Front Wheel” 44B and press the “LF” button 44L, which will copy all of the data from the “Left Front Wheel” 44A to the “Right Front Wheel” 44B, including Tire Size, Wheel Size, Wheel Type, Brand and Tread, so that the user does not have to enter any of the data (similar to a copy and paste functionality). If the inspector finds any of the fields to be different from the Left Front Wheel, the inspector can edit that one field, instead of having to complete all five fields. The inspector can also use the “copy and paste” feature for each of the other tires and wheels. On FIG. 5, the inspector pressed the Damage Quick Add “Minus” Button 440 on the “Right Rear Tire/Wheel” 44D, which auto-generated a Damage Line Item 101P, displayed on FIG. 3A, of “Part-RR Tire” 89P; “Damage-Missing” 91D; “Severity-Replacement Required” 93C; “Remedy-Replace” 95C. If the inspector were to press the “OS” 44P (On Spare) Damage Quick Add Button, a damage line item would have been auto-generated of “Part-RR Wheel”; “Damage-On Spare”; “Severity-Replacement Required”; “Remedy-Replace”. The inspector previously pressed the “Wrench” icon 85 on the “Tire Inflate Kit” button 44Q and selected “Missing” 44R in the drop-down menu, which auto-generated the following Damage Line Item 101Q on FIG. 3A, “Part-Tire Inflate Kit” 89Q; “Damage-Missing” 91D; “Severity-Replacement Required” 93C; “Remedy-Replace” 95C.

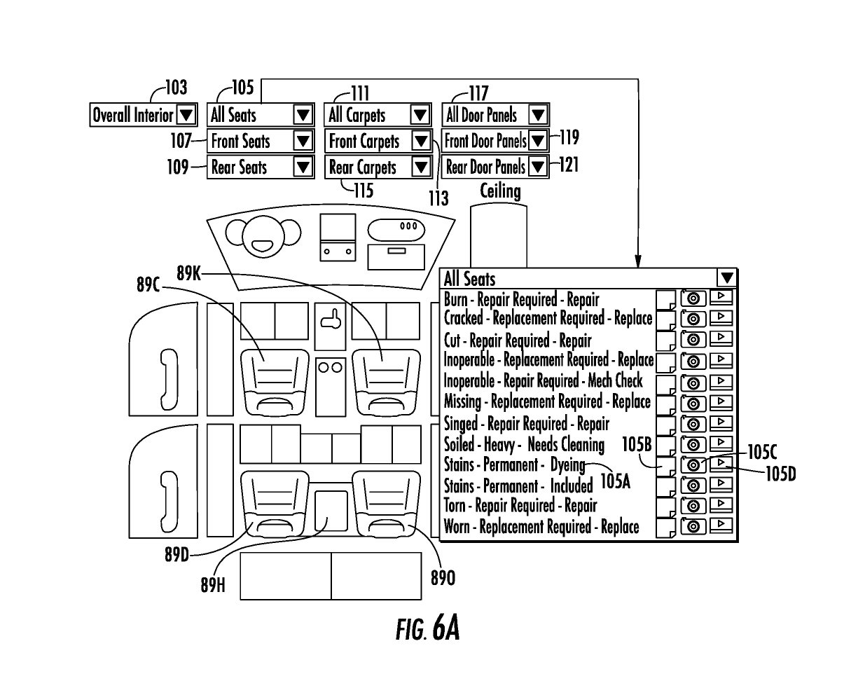

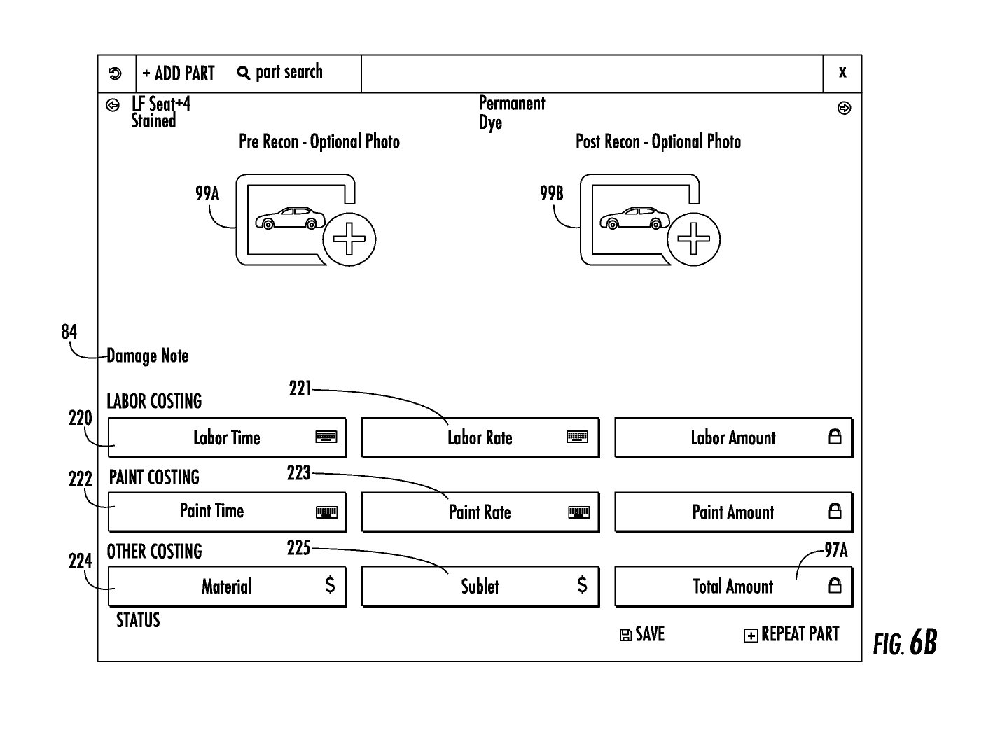

As displayed in FIG. 6A, the Damage Quick Add Buttons can be used to quickly add multi-part damage line item exceptions and/or single part damage line item exceptions. FIG. 6A provides an interior damage quick assessment, allowing an inspector to add similar damage line items for multiple grouped parts with a two-click dropdown Quick Add Damage Button. A user may choose to add multiple similar damage line items to similar parts that are grouped together. Some of the groupings of parts include, but are not limited to, “overall interior” 103, “All Seats” 105, “Front Seats” 107, “Rear Seats” 109, “All Carpets” 111, “Front Carpets” 113, “Rear Carpets” 115, “All Door Panels” 117, “Front Door Panels” 119, and “Rear Door Panels” 121. As displayed in FIG. 6A, the two-click damage line item button “All Seats” 105 can generate multiple damage line items with Part, Damage, Severity and/or Remedy or action for multiple parts with two-clicks. If the user selects the “All Seats” 105 Damage Quick Add Button, each of the seats are highlighted on FIG. 6, including the Left Front Seat 89C, Left Rear Seat 89D, Rear Center Seat 89H, Right Front Seat 89K and Right Rear Seat 89O, and then presses the “Stains-Permanent-Dyeing” 105A in the drop-down menu, the following damage line items will be auto-generated on FIG. 3 for each the “Left Front Seat” 101C, “Left Rear Seat” 101D, “Rear Center Seat” 101H, “Right Front Seat” 101K and “Right Rear Seat” 101O. If the user were to press the “Camera” icon 105C to the right of the “Stains-Permanent-Dyeing” 105A in the drop-down menu, the aforementioned Damage Line Items (101C, 101D, 101H, 101K and 101O) would still get auto-generated, but the user would also be prompted to take five (5) sequential photos, starting with the left front seat, then the right front seat, left rear seat, rear center seat, and lastly, the right rear seat. If the user were to press the “Video” icon 105D on the “Stains-Permanent-Dyeing” 105A drop-down menu item, the aforementioned damage line items would also still get created, but the user would be prompted to take a single video, also in sequential order, starting with the left front seat, then the right front seat, left rear seat, rear center seat, and lastly, the right rear seat. If the user were to press the “Note” icon 105B on the “Stains-Permanent-Dyeing” 105A drop-down menu item, the damage line items would also still get created, but the user would be prompted to document a note that would apply to each damage line item in the “Note” column 84 on FIG. 3A. This is not provided in the example, but if the Quick Add Button “Front Carpets” 113 was selected and the corresponding drop-down menu item was activated, two damage line items would be auto-generated; one for the Left Front Carpet and one for the Right Front Carpet. The activation of multiple damage line item exceptions using a two-click damage line item button could auto-generate one or multiple estimate request(s), work order(s), other workflows, and/or transport/driver request(s) requesting to transport the vehicle or schedule logistics for the vehicle to a corresponding vendor or lot, initiate, schedule or automate other workflow, or be used to make optimized decisions or to make optimized decision recommendations. The one-click and two-click Quick Add damage line item button groupings, the Damage Quick Add Buttons, their corresponding damage selections and the subsequent physical action(s) can all be configured uniquely or determined by editing rows in a table for the following, including, but not limited to, each user's or seller's business rules, seller type or by any vehicle type, condition data, any vehicle attribute or vehicle specific data or combinations thereof.

FIG. 6B displays the alternative save method for the Damage Quick Add button that allows for editing of the pre-determined fields, such as estimated “Labor Time” 220, “Labor Rate” 221, “Paint Time” 222, “Paint Rate” 223, “Material” 224 or “Sublet” 225 costs, which editing any of the aforementioned fields will update the “Total Amount” field 97A. Referring back to FIG. 6A, after pressing the “Stains-Permanent-Dyeing” 105A in the drop-down menu, instead of immediately saving the following damage line items on FIG. 3A/3B for each of the “Left Front Seat” 101C, “Left Rear Seat” 101D, “Rear Center Seat” 101H, “Right Front Seat” 101K and “Right Rear Seat” 101O, the software configuration can allow the alternative save method page displayed in FIG. 6B to appear. From this page, a user may also add a “Damage Note” 84, take a pre-recon photo with the “Pre-Recon Photo” button 99A, take a post-recon photo with the “Post-Recon Photo” button 99A, suggest repairs or edit other fields related to the damage line items when necessary and then press the “Save” button 106 to save the auto-generated damage line items and any of the edited fields on FIG. 6B. Referring back to FIG. 6A, if the user selects the “All Seats” 105 Damage Quick Add Button, each of the seats are highlighted on FIG. 6A, including the Left Front Seat 89C, Left Rear Seat 89D, Rear Center Seat 89H, Right Front Seat 89K and Right Rear Seat 89O, and then presses the “Stains-Permanent-Dyeing” 105A in the drop-down menu, the following damage line items will be auto-generated on FIG. 3A or 3B for each the Left Front Seat 101C, Left Rear Seat 101D, Rear Center Seat 101H, Right Front Seat 101K and Right Rear Seat 101O; and with the alternative save method in FIG. 6B, the user was allowed to edit estimated costs, enter a Damage Note, take damage line item photos, suggest repairs, and/or edit other fields related to the multiple damage line items.

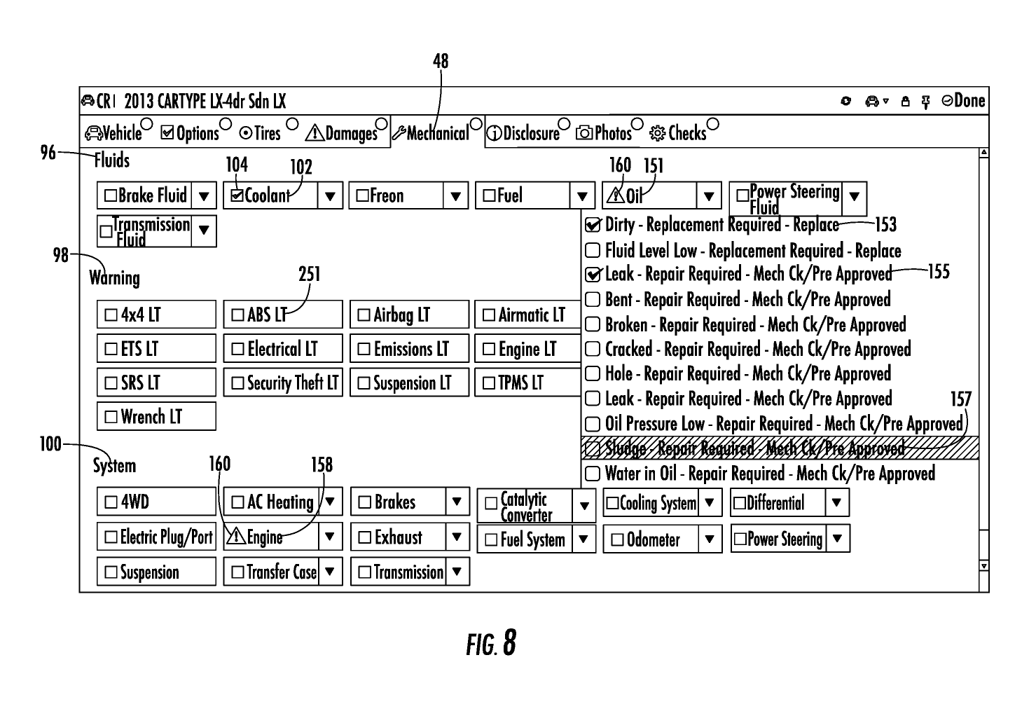

As displayed on FIGS. 4, 6, 8 and 9, the Damage Quick Add Buttons can be used to quickly add exterior, interior or mechanical damage line item exceptions. The configurations allow for the Damage Quick Add Buttons to have any custom, defined damage line item exception combinations available in any custom Quick Add Button drop-down menu list, meaning that any “Part” 89-“Damage” 91-“Severity” 93-“Remedy” 95 combinations (see FIG. 3A-3B) can be available menu items on the Damage Quick Add Buttons and auto-generate corresponding, custom damage line items onto the Damage Line Item List 87. A custom tab, similar to the “Mechanical” tab 48 in FIG. 8 or the “Overall Interior” 103 section in FIG. 6, can be created for any area of the vehicle and contain Damage Quick Add Buttons for any part of a vehicle, including, but not limited to, options, equipment, accessories, interior, exterior, body, glass, trim, wheels, tires, frame, unibody or structural. For example, if an inspection company or seller chooses to have a “Frame” damage quick assessment page with Quick Add Buttons for the most common frame parts, a page with all of the Damage Quick Add Buttons for the required frame parts can be generated and configured by simply adding rows to a database table. The Damage Quick Add Buttons can contain as many damage exceptions as needed. The Damage Quick Add Buttons also allow the inspector to indicate they have checked an area and have not found a problem, meaning that it is operating as it should. As displayed on FIG. 8, the “Coolant” button 102 has been check marked at 104, documenting that the coolant has been checked and is in good shape. When any selection on the Damage Quick Add Button is activated, whether operating or damaged, it can be configured to require a video, a photo, a note or other data by editing rows in a database table. This can be very useful to ensure all important or required areas are inspected.

FIG. 8 is a screen shot of the “Mechanical” Tab 48. As shown, the condition information regarding the “Fluids” group 96, the “Warnings” group 98 and the “System” group 100 can be noted after being inspected by the inspector. These “Mechanical” tab 48 groups each have multiple Damage Quick Add Buttons, enabling a user to create damage line items in one or two clicks for any part on the “Mechanical” tab 48. FIG. 8 displays the “Oil” button 151 having been selected and two damages have been activated, “Dirty-Replacement Required-Replace” 153 and “Leak-Repair Required-Mech Ck/Pre-Approved” 155, to create two damage line items associated with the vehicle's oil. Once the “Oil” button 151 is selected and the two damages 153 and 155 are activated, two damage line items are auto-generated on the Damage Line Item List 87, see FIG. 3A: “Oil-Leak-Repair Required-Mech Ck/Pre-Approved” 101F and “Oil-Dirty-Replacement Required-Replace” 101G. This example displays that multiple damage line items can be auto-generated for “Oil” or any other part with the Damage Quick Add Buttons, each with a single click. The “Sludge-Repair Required-Mech Ck/Pre-Approved” 157 was not checked, indicating no damage exception required for sludge or any of the other unchecked damage items on the Oil button 151. The “ABS LT” 251 is not selected. It could have been selected with a single click that would auto-generate a damage line item “Part-ABS LT”; “Damage-On”; “Severity-Repair Required”; “Remedy-Mech Ck/Pre-Approved” (not shown) and, depending on the seller's business rules, could have auto-generated an announcement/disclosure or an estimate request order and a transport order. The “Coolant” button 102 has been activated, with the check mark 104, to indicate no problems found. If a problem was detected, clicking on the drop-down arrow on the Damage Quick Add “Coolant” button 102 will provide a drop-down menu item list to add a damage line item to “Coolant” 102. As displayed on FIG. 8, the Damage Quick Add Buttons can be used to quickly add mechanical damage line item exceptions.

Such Quick Add Damage Buttons can be used for any area of the vehicle, including, but not limited to, the interior, exterior, body, glass, trim, frame, unibody, structural, mechanical, options, equipment, wheels, or tires.

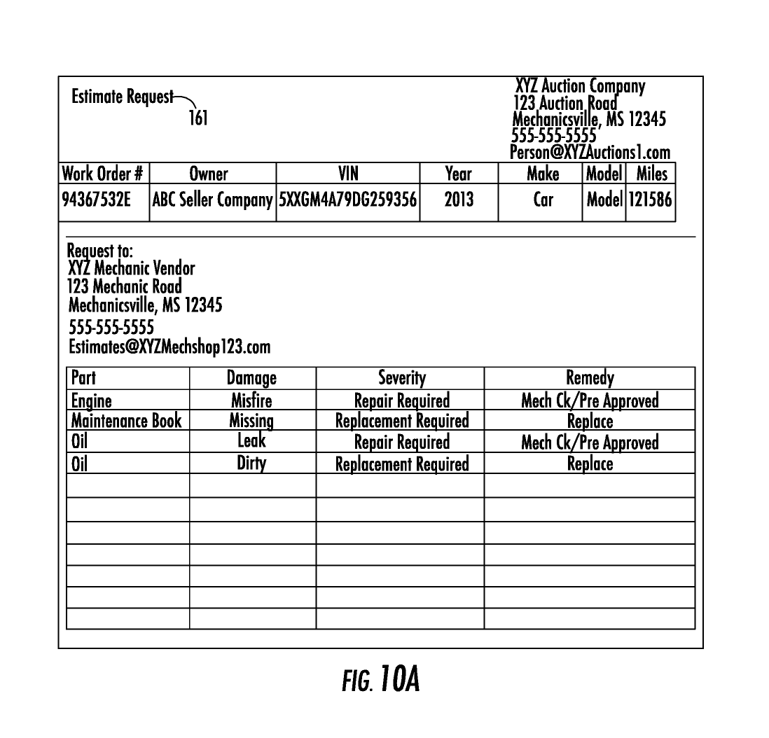

The activation of a damage line item exception using a Damage Quick Add Button could auto-generate work orders or estimate requests, see Estimate Request 161, FIG. 10A, or Transport Order 167, FIG. 10B, optimize and automate decision making, schedule logistics and workflow processes online and in the physical world, and make optimized decision recommendations. The Damage Quick Add Buttons, their selections, and the subsequent physical action(s) can all be configured uniquely or determined by editing rows in a table for the following, including, but not limited to: each user's or seller's business rules, seller type or by any vehicle type, condition data, any vehicle attribute or vehicle specific data, or combinations thereof.

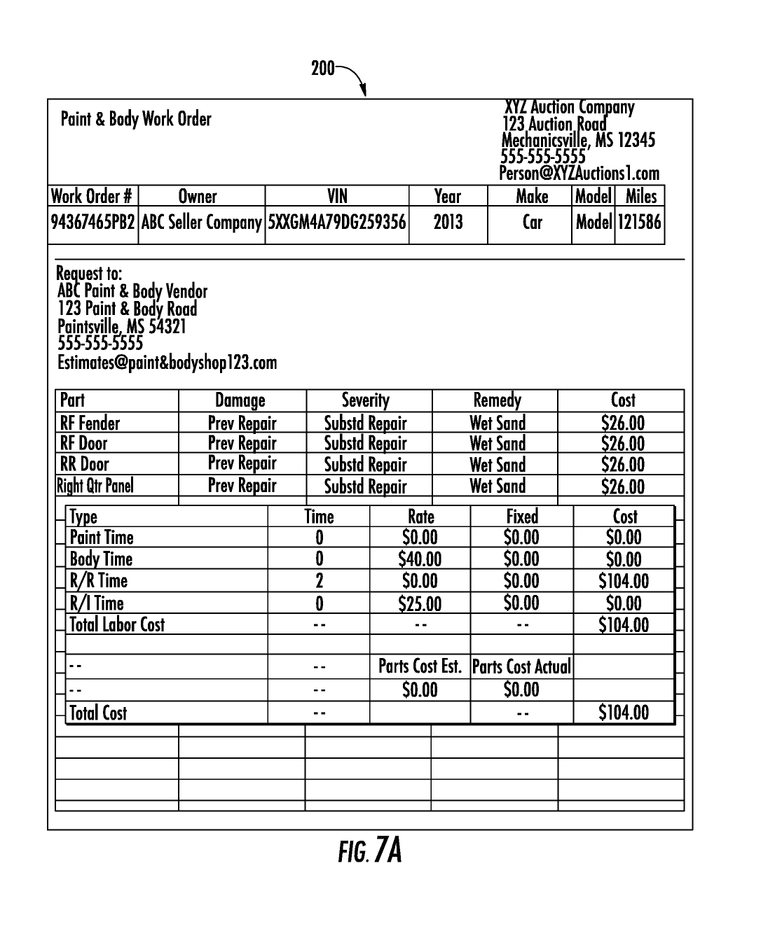

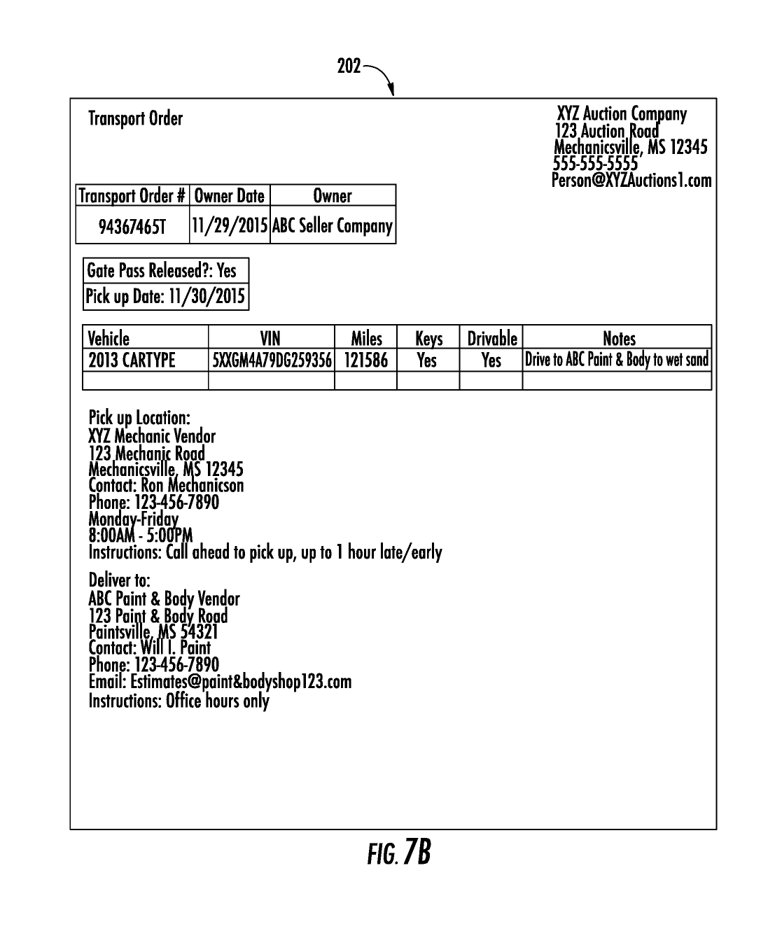

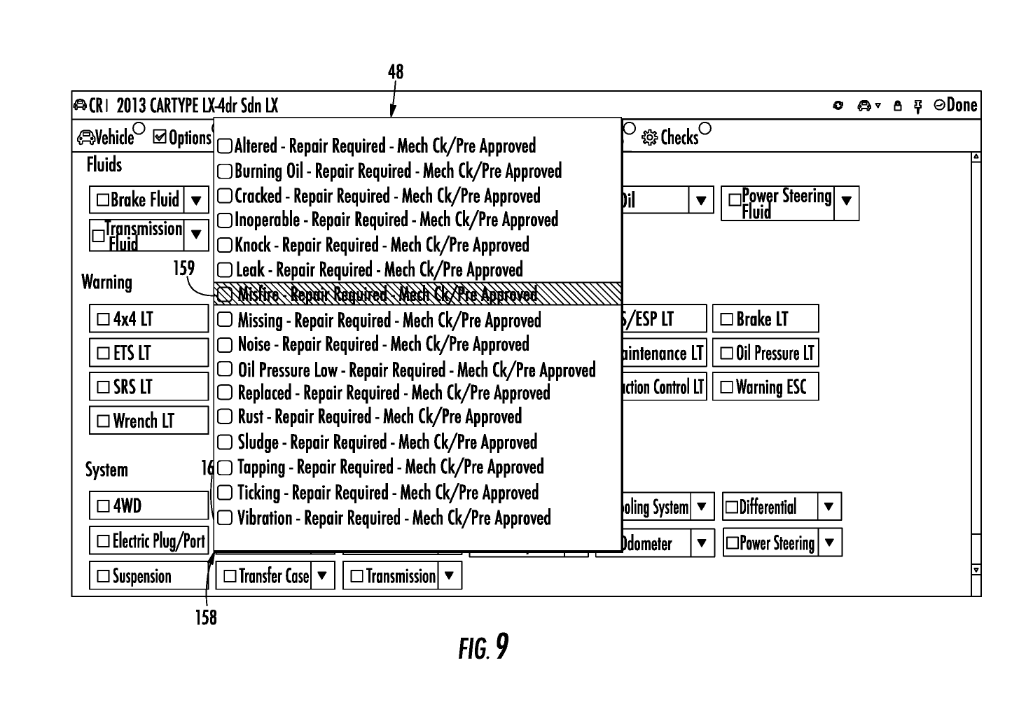

FIG. 9 is a screen shot illustrating the creation of a damage line item associated with the vehicle's engine. As illustrated, the inspector has pressed the “Engine” button 158 that is visible in FIG. 8, and in FIG. 9 has activated the “Engine-Misfire-Repair Required” button 159. Such action auto-generates the Damage Line Item “Part-Engine” 89B; “Damage-Misfire”91B; “Severity-Repair Required” 93A; “Remedy-Mech Ck Pre-Approved” 95A, see FIG. 3A-3B. In FIG. 8, the “Engine” button 158 and the “Oil” button 151 are both displayed with a Caution icon 160, signifying an issue with the oil and the engine. As displayed on FIG. 12, this action can auto-generate an announcement or announcement recommendation 135, such as “Engine Misfire” on the “Disclosure” Tab 50. These Damage Quick Add Buttons have vehicle-specific, user-specific and/or seller-specific configurations and business rules for generating an Estimate Request 161, see FIG. 10A, or Work Order 200 similar to that shown FIG. 7A, a Transport/Driver's Order 202, as shown in FIG. 7B, and similar to that shown in FIG. 10B, or auto-generating an announcement/disclosure 135 or announcement/disclosure recommendation that can all be created or edited by adding, editing or removing rows in a database table. A seller could pre-determine for the vehicle to go to the mechanic shop for an estimate request or pre-approved repairs; while a different seller may configure the settings to disregard a possible repair and instead auto-generate a disclosure of “Engine-Misfire”. In this case, the seller has pre-determined for any engine issue to go to the mechanic for an estimate to repair, and the Estimate Request 161, FIG. 10A, was auto-generated. The seller also pre-approved repairs to be made on any item related to the engine that costs less than $350.00. The seller has also pre-determined that any vehicle that has a “Part-Oil” with “Damage-Leak” will automate an Estimate Request 161 for the repairs. The seller has also pre-determined that any vehicle that has a “Part-Oil” with “Damage-Dirty” will confirm the cost to change the oil in an Estimate Request 161 and to repair. The seller has also pre-determined that any vehicle that has a “Part-Maintenance Book” with “Damage-Missing” to confirm the cost to replace the Maintenance Book in an Estimate Request 161. If the seller had not pre-determined these business rules, the application could send out a notification to the seller with recommendations that will earn a net return on investment for performing certain reconditioning and repairs. As each Damage Quick Add Button is activated with a damage that meets the seller's rules for estimate requests, each damage line item is added to the Estimate Request 161 that was generated by the initial damage activated on a Damage Quick Add Button, in this case the “Part-Engine” and “Damage-Misfire”. FIG. 10B displays a Transport Order 167 that was auto-generated from this single Damage Quick Add Button to transport the vehicle to XYZ Mechanic Vendor to obtain an estimate to repair the engine, find and repair the oil leak, change the oil, and replace the Maintenance Book.

In FIGS. 11A-11G, multiple damage line items that are similar can be created for multiple parts by selecting each part and then selecting only one Damage, one Severity and one Remedy. This enables a user to quickly generate multiple damage line items with any Damage, Severity and Remedy combination, without having to pre-determine the selections available for Damage, Severity and Remedy. The activation of multiple damage line item exceptions using the multi-part, similar damage line item process could auto-generate one or multiple Estimate Request(s), Work Order(s) and/or Transport/Driver Request(s) to transport the vehicle or schedule logistics for the vehicle to a corresponding vendor or lot, initiate, schedule or automate other workflow, or be used to make optimized decisions or recommendations.

FIGS. 11A and 11B provide a screen shot of the Exterior Damage Line Item Selector 169 prior to selecting any part(s) with the “1:1” button 174 activated, which means that each panel on the exterior vehicle image 172 can only map to a single part. The existing Damage Line Items List 87 contains a “Part” 89, a “Damage” 91, a “Severity” 93, a “Remedy” 95, a “Note” 84, and the estimated repair “Cost” 97. As displayed in FIG. 11B, if the “1:1” button 174 is de-selected and a user selects the “Right Front Door” 89I (by clicking on the picture of that door as illustrated by the darkened panel in the figure), the Exterior Damage Line Item Selector 169 will provide parts only associated with the Right Front Door, such as the Right Front Door 89I, the Right Front Door Edge 89I-2, the Right Front Door Handle 89I-3, or the Right Front Door Inner 89I-4. If the user were to deselect the “Common” button 176, more parts related to the Right Front Door would become available on the Exterior Damage Line Item Selector 169.

FIG. 11C displays the Exterior Damage Line Item Selector 169 in Multi-Part, Similar Damage Line Item mode. The vehicle gets put into Multi-Part Similar Damage Line Item Mode as soon as the user selects a second part. A user, such as a vehicle inspector, can use the Exterior Damage Line Item Selector 169 to select multiple parts to activate multiple similar damage line items for multiple parts. In FIG. 11C, the user has selected the “Right Qtr Panel” 89L, the “RR Door” 89N, “RF Door” 89I and the “RF Fender” 89J. As soon as the first part is selected, the user may select a single damage from any of the available damages, such as “Dent/No Paint Dmg” 91I, “Dent/Paint Dmg” 91H, “Hail Damage” 91J, “Prev Repair” 91G, or any of the other available damages. As illustrated in FIG. 11C, the “Damage-Prev Repair” 91G has not been selected. Referring to FIG. 11D, the “Damage-Prev Repair” 91G has been selected, while “Severity-Substd Repair” 93D has not been selected.

In FIG. 11E, the “Severity-Substd Repair” 93D has been selected, while “Remedy-Wet Sand” 95D has been selected. In FIG. 11F, “Remedy-Wet Sand” 95D has been selected, leaving the user the option to adjust labor time or parts repair estimates. This action will adjust the total line item repair estimate Cost 97A, take sequential photos, take a video with the Camera button 94 and/or add notes 84B; all which can be linked to the damage line items. The user can either press “Save” 106 and auto-generate four damage line items or press “Save/Add” 108, which will add the four damage line items as well, and enable the user to add additional damage line items to the same parts without having to select any parts on the “Exterior Vehicle Image” 172 again. After pressing the “Save” button 106, the Exterior Damage Line Item Selector 169 in Multi-part Similar Damage Line Item mode auto-generated the four damage line items, 101L, 101N, 101I, 101J, as illustrated on FIGS. 3A-3B, all by pressing or clicking only nine (9) times, including part selection and the Save button. If there were two (2) additional exterior parts that had been previously repaired, adding those two additional damage line items would require only two (2) additional clicks or button presses, one per part, meaning that six (6) damage line items would be auto-generated by pressing or clicking a total of eleven (11) times.

Each damage line item will be generated with a unique Part 89, but with the same Damage 91, Severity 93 and Remedy 95. In this case, see FIGS. 3A-3B, damage line item 101L was generated with “Part-Right Qtr Panel” 89L; “Damage-Prev Repair” 91G; “Severity-Substd Repair” 93D; “Remedy-Wet Sand” 95D. Each of the other damage line items, 101N, 101I and 101J, were auto-generated with a different Part, but the same Damage, Severity and Remedy combinations. The Damage Line Item exception selector, whether exterior, interior, mechanical, frame or other area of a vehicle, enables the inspector to select any allowed Part, Damage, Severity and Remedy combination for one or multiple parts. This activation could also auto-generate the work order, such as the Paint & Body Work Order 200 illustrated on FIG. 7A, to wet sand all four panels, and the Transport Order 202 illustrated on FIG. 7B based on the seller's business rules. These business rules and configurations could be based on the seller, Part, area, Damage itself, the Severity, Note, Remedy or action, the year, make, model, the mileage or any other vehicle or inspection condition attribute, or combinations thereof.

FIG. 11G illustrates a screen shot of an Interior Damage Line Item Selector 183 in Multi-Part Similar Damage Line Item Mode with an interior vehicle image 175. FIG. 11G functions the same way as FIGS. 11A through 11F, but is for the interior, instead of the exterior, of the vehicle. The Damage Line Item Selectors displayed in FIGS. 11A through 11F, and in FIG. 11G, can be used for any area of the vehicle, including, but not limited to, the frame, unibody, undercarriage, mechanical items, tires, wheels, options, equipment, and/or glass. In addition to auto-generating work orders, estimate requests, transport orders and other workflows, the damage line items that are auto-generated by the Damage Line Item Selector and the Quick Add Damage Buttons in each of the figures are configured to add to the data used to optimize and automate decision making, schedule logistics and workflow processes online and in the physical world, and make optimized decision recommendations that remove bottlenecks, and that may impact the sale of the vehicle. The damage line item selector process, the exterior vehicle image 172, the interior vehicle image 175, images for other areas of the vehicle, the available Parts 89, Damages 91, Severities 93, Remedies 95, Notes 84 and estimated Costs 97, and/or the subsequent notifications and physical world actions, can all be configured uniquely or determined by editing rows in a table for the following, including, but not limited to, any vehicle attribute, vehicle type, condition data, seller type or by seller, inspector or user specific business rules, other data, machine learning, or combinations thereof.

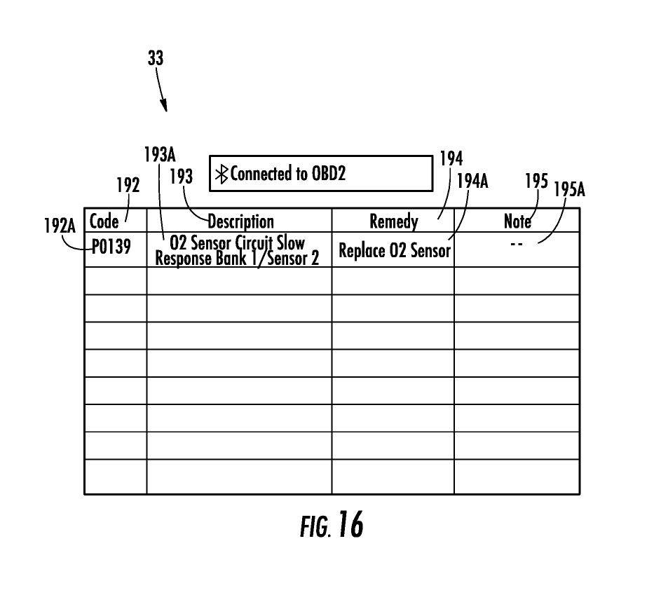

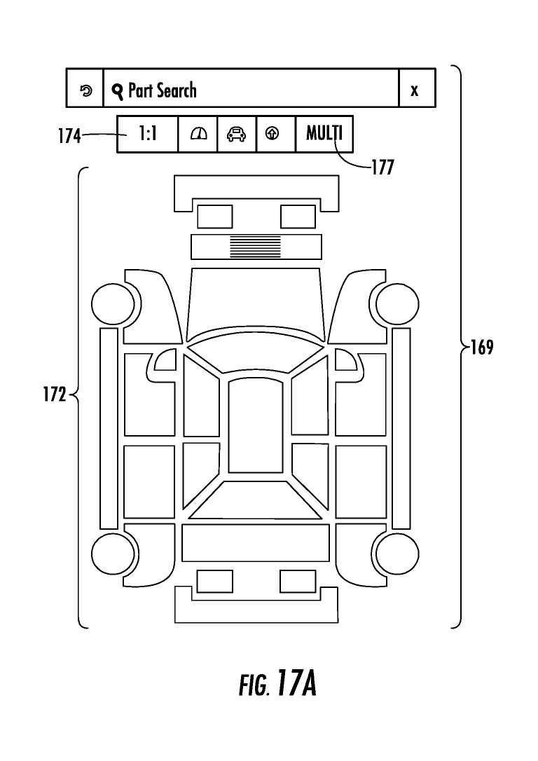

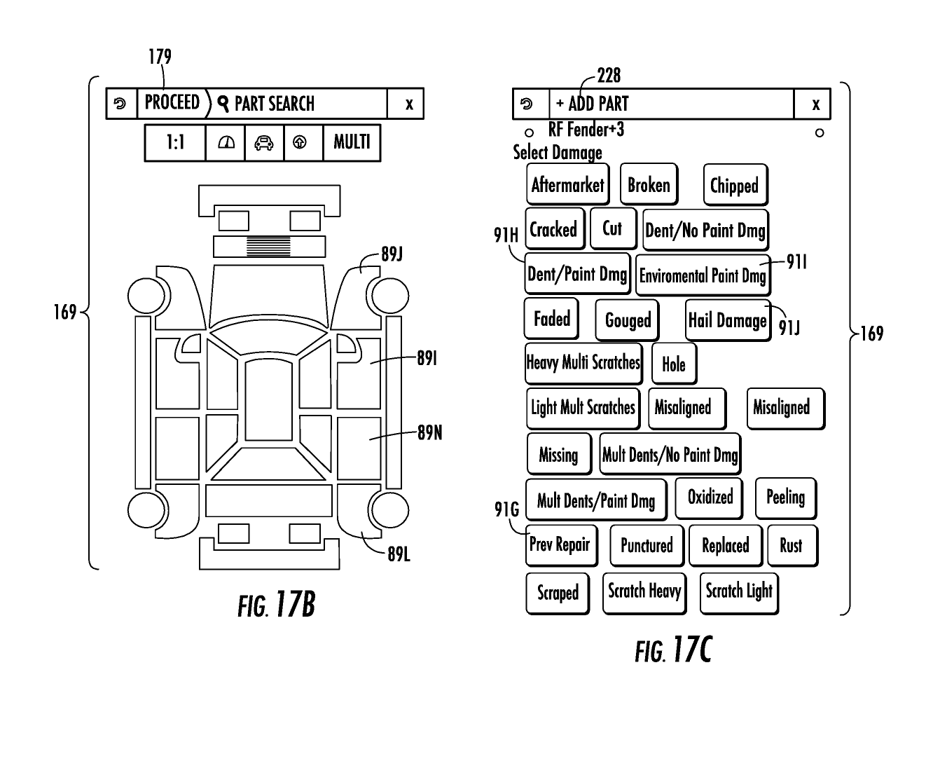

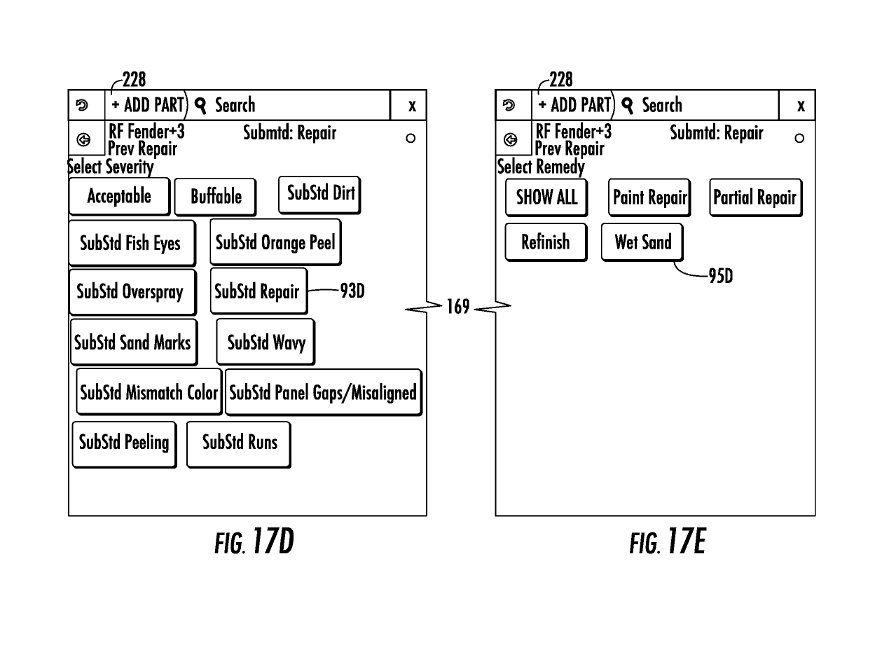

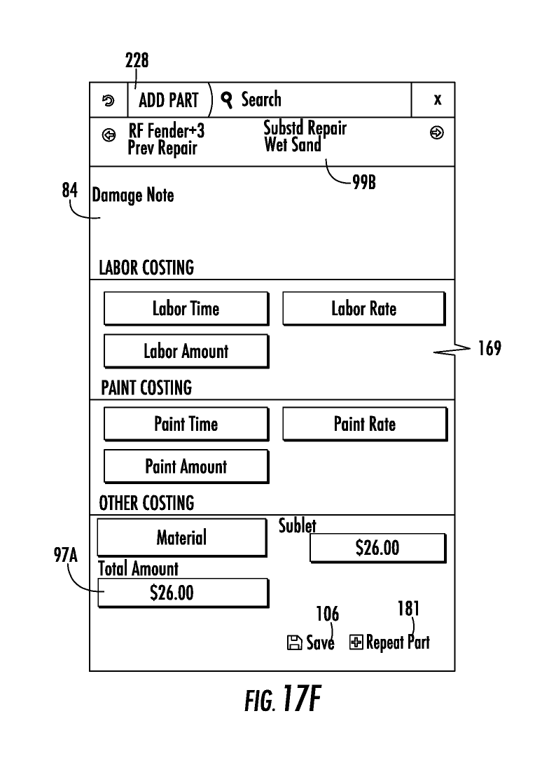

FIGS. 17A-17F illustrate a slightly modified alternative method for the “Exterior Damage Line Item Selector” 169 and the “Exterior Vehicle Image” 172 designed for a smaller device, such as a smart phone. FIG. 17A illustrates a screen shot of the “Exterior Vehicle Image” 172 with the “1:1” button 174 and the “Multi-Part” button 177 activated, which means that each panel on the “Exterior Vehicle Image” 172 can only map to a single part, and that the user can now select multiple parts to create multiple damage line items. A user, such as a vehicle inspector, can use the “Exterior Vehicle Image” 172 to select multiple parts to activate multiple similar damage line items for multiple parts. In FIG. 17B, the user has selected the “Right Qtr Panel” 89L, the “RR Door” 89N, the “RF Door” 89I, and the “RF Fender” 89J. As displayed in FIG. 17B, as soon as the user has selected the parts with similar damages, the user may press the “Proceed” button 179. Once the “Proceed” 179 button on FIG. 17B is pressed, the user is brought to FIG. 17C and may select a single damage from any of the available damages, such as “Dent/No Paint Dmg” 91I, “Dent/Paint Dmg” 91H, “Hail Damage” 91J, “Prev Repair” 91G, or any of the other available damages. As illustrated in FIG. 17C, the “Damage-Prev Repair” 91G has not yet been selected. Referring to FIG. 17D, the “Damage-Prev Repair” 91G has been selected, while “Severity-Substd Repair” 93D has not yet been selected. While on FIG. 17C, 17D, 17E or 17F, the user may press the “Add Part” button 228 to add an additional part if the user notices another part on the vehicle that has a similar damage as the others being documented with Previous Repair. In FIG. 17E, the “Severity-Substd Repair” 93D has been selected, while “Remedy-Wet Sand” 95D has not yet been selected. In FIG. 17F, “Remedy-Wet Sand” 99B has been selected, leaving the user the option to adjust labor time or parts repair estimates. This action will adjust the total line item repair estimate Cost 97A, enable the user to take sequential photos or take a video with the Camera button 99B and/or add notes 84; all which can be linked to the damage line items. The user can either press “Save” 106 and auto-generate four damage line items, or press “Repeat Part” 181, which will add the four damage line items as well, and enable the user to add additional damage line items to the same parts without having to select any parts on the “Exterior Vehicle Image” 172 again. After pressing the “Save” button 106, the Exterior Damage Line Item Selector 169 in Multi-part Similar Damage Line Item mode will have auto-generated the four damage line items, 101L, 101N, 101I, 101J, as illustrated on FIG. 3A, all by pressing or clicking only ten (10) times, including part selection and the “Save” button 106. If there were two (2) additional exterior parts that had been previously repaired, adding those two additional damage line items would require only two (2) additional clicks or button presses; one per part; meaning that six (6) damage line items would be auto-generated by pressing or clicking a total of twelve (12) times. Each damage line item will be generated with a unique Part 89, but with the same Damage 91, Severity 93 and Remedy 95. In this case, see FIG. 3, damage line item 101L was generated with “Part-Right Qtr Panel” 89L; “Damage-Prev Repair” 91G; “Severity-Substd Repair” 93D; “Remedy-Wet Sand” 95D. Each of the other damage line items, 101N, 101I and 101J, were auto-generated with a different Part, but the same Damage, Severity and Remedy combinations. The Damage Line Item exception selector, whether exterior, interior, mechanical, frame or other area of a vehicle, enables the inspector to select any allowed Part, Damage, Severity and Remedy combination for one or multiple parts. This activation could also auto-generate the work order, such as the Paint & Body Work Order 200 illustrated on FIG. 7A, to wet sand all four panels, and the Transport Order 202 illustrated on FIG. 7B based on the seller's business rules. These business rules and configurations could be based on the seller, Part, area, Damage itself, the Severity, Note, Remedy or action, the year, make, model, the mileage or any other vehicle or inspection condition attribute, or combinations thereof.

Referring back to FIG. 3A, if a damage line item was created by a Damage Quick Add Button (i.e. FIG. 3A, 101A was auto-generated with the “Part-CD Player”; “Damage-Inoperable”; “Severity-Repair Required”; “Remedy-Mech Ck/Pre-Approved”), the damage line item on FIG. 3A will have a “Gear” icon 201 to the far left of the damage line item. The “Gear” icon 201 lets the user know that this damage line item was auto-generated by the CD Player 82 Quick Add Damage Button 90 on FIG. 4A, and, if the user would like to delete the damage line item, it can be deleted from the same Quick Add Damage Button that created the damage line item. If the damage line item was created using the “Exterior Damage Line Item Selector” 169 with the “Exterior Vehicle Image” 172 displayed in FIGS. 11B-11F, the damage line items on FIG. 3A will have a “Minus Sign” icon 205 and an “Edit” icon 101 to the left of the damage line item. If a user presses the “Minus Sign” icon 205 on FIG. 3A, the user will be prompted to confirm that they would like to delete the damage line item. If a user presses the “Edit” icon 101 to the left of the damage line item on FIG. 3A or FIG. 11A, it will take the user to the “Exterior Damage Line Item Selector” 169 to edit the damage line item. On FIG. 3A or FIG. 11A, if a user presses on any specific field cell for “Part” 89, “Damage” 91, “Severity” 93, “Remedy” 95, “Note” 84 or “Cost” 97, the user will be taken directly to the corresponding page on the “Exterior Damage Line Item Selector” 169 on FIGS. 11B through 11F in order to edit the specific field cell for that damage line item's “Part”, “Damage”, “Severity”, “Remedy”, “Note” or “Cost” that the user pressed on the damage line item grid. If the “Photo” button 99 is blue, that means there is a photo and/or video linked to the damage line item. If the “Photo” button 99 is grey, there is no photo or video linked to the damage line item. If a photo or video was not linked to the damage line item while capturing the damage line item on a Damage Quick Add Button or while using the Exterior Damage Line Item Selector 169, the user can press on the “Photo” button 99 to take a photo and/or video and link the photo and/or video to the damage line item that is to the right of the camera icon the user pressed.

In an alternative embodiment, the damage line item list shown in FIG. 3B may contain a “Menu” button 230 (three stacked bars) to the left of each damage line item, providing the user with actions that can be taken on each damage line item. As shown in FIG. 3C, the user has pressed the “Menu” button 230 (three stacked bars) to the left of damage line item 101I. The five actions available to the user are “Duplicate Dmg for Multi-Parts” 227, “Duplicate Damage” 229, “Edit” 232, “Photo” 99 and “Delete” 205. If a user presses the “Delete” button 205 on FIG. 3C, the user will be prompted to confirm that they would like to delete the damage line item. If a user presses the “Edit” button 232 to the left of the damage line item on FIG. 3C or FIG. 11A, it will take the user to the “Exterior Damage Line Item Selector” 169 to edit the damage line item. If the “Photo” button 99 is blue, that means there is a photo and/or video linked to the damage line item.

If the “Photo” button 99 is grey, there is no photo or video linked to the damage line item. If a photo or video was not linked to the damage line item while capturing the damage line item on a Damage Quick Add Button or while using the Exterior Damage Line Item Selector, the user can press on the “Photo” button 99 to take a photo and/or video and link the photo and/or video to the damage line item that is to the right of the camera icon the user pressed. In FIG. 3C, the user can press the “Duplicate Damage” button 229 on damage line item 101I, enabling the user to quickly capture the same exact damage line item as 101I, but for a different part. Once the “Duplicate Damage” button is pressed on FIG. 3C, FIG. 3D appears with the Exterior Damage Line Item Selector 169, enabling the user to select the part for which they would like to duplicate the damage for. In FIG. 3D, the user can select the “Left Quarter Panel” 231. Once the user selects the “Left Quarter Panel” 231, the “Save” button 106 can be pressed on FIG. 3E, which will duplicate the damage from damage line item 101I, creating a new damage line item on FIG. 3B, 101R with “Part-Left Qtr Panel” 89R; “Damage-Prev Repair” 91G; “Severity-Substd Repair” 93D; “Remedy-Wet Sand” 95D. In FIG. 3C, the user can also press the “Duplicate Dmg for Multi-Parts” button 227 on damage line item 101I, enabling the user to quickly capture the same exact damage line item as 101I, but for multiple different parts.

Once the “Duplicate Dmg for Multi-Parts” button is pressed on FIG. 3C, FIG. 3F appears with the Exterior Damage Line Item Selector 169 and the “1:1” button 174 and the “Multi-Part” button 177 automatically activated, enabling the user to select multiple parts for which they would like to duplicate the damage for. In FIG. 3G, the user has selected the “LF Fender” 188, the “LF Door” 189 and the “LR Door” 196. Once the user has selected the aforementioned parts and then presses the “Proceed” button 179 as displayed in FIG. 3G, the “Save” button 106 can be pressed on FIG. 3H, which will duplicate the damage from damage line item 101I, creating 3 new damage line items on FIG. 3B, for each the “LF Fender-Prev Repair-Substd Repair-Wet Sand”, “LF Door-Prev Repair-Substd Repair-Wet Sand”, and “LR Door-Prev Repair-Substd Repair-Wet Sand”.

FIG. 12 is a screen shot of the “Disclosure” Tab 50. The “disclosures” can be a simple checkbox in which the box is checked if the disclosure is needed, and left unchecked if not needed. Typically, disclosures refer to announcements which may positively affect the sale of a vehicle, or that may be required to announce in order to provide full disclosure of issues and avoid arbitration. However, the seller can define as many disclosure configurations as needed so different sellers/vehicles can have different disclosures recommended or auto-generated by the damage line item exceptions and/or other data determined during the inspection process. Various disclosures shown in FIG. 12 include those relating to the “Title/Odometer” 112, including for example, “Canadian Registration” 114, “Gray Market Vehicle” 116, “Not Actual Miles” 118, “Odometer Discrepancy” 120, “Odometer Rollback” 122, “Odometer Rollover” 124, “Repo Papers” 126, “Second Lien” 128, and “TMU” 130.

FIG. 12 also illustrates “As Is” notations 131, including “As Is” 132, “As Is Age” 134, and “As Is Over 100K” 136 disclosures. The “As Is” 132 disclosure has been activated, which generated the announcement “As Is” 133. Additional disclosures can be automatically configured to create announcements, such as announcements that would be classified or “grouped” as “Major Damage” 138, “Manufacturer” 140, as well as other groupings not displayed on FIG. 12, such as “Usage” related and “Other” groups. These groups can all be customized, and any disclosure can be added within a group with simple table configurations. Disclosures and announcements or announcement recommendations can also be auto-generated by damage line items created from Damage Quick Add Buttons and/or from the Damage Line Item Selector or other damage line item creation method. In FIG. 9, the inspector has activated “Engine-Misfire-Repair Required” 159 and has auto-generated the damage line item “Part-Engine”; “Damage-Misfire”; “Severity-Repair Required”; “Remedy-Mech Ck Pre-Approved” 101B on FIG. 3A.

In FIG. 12, the seller configured the settings to disregard a possible repair and instead auto-generate a disclosure of “Engine-Misfire” 135. The disclosures can be grouped together. The groupings and the disclosures are displayed on the interface dynamically. Simple configurations can be made to the interface by adding, editing or removing rows in the database in order to dynamically add, edit or remove disclosures and the groupings.

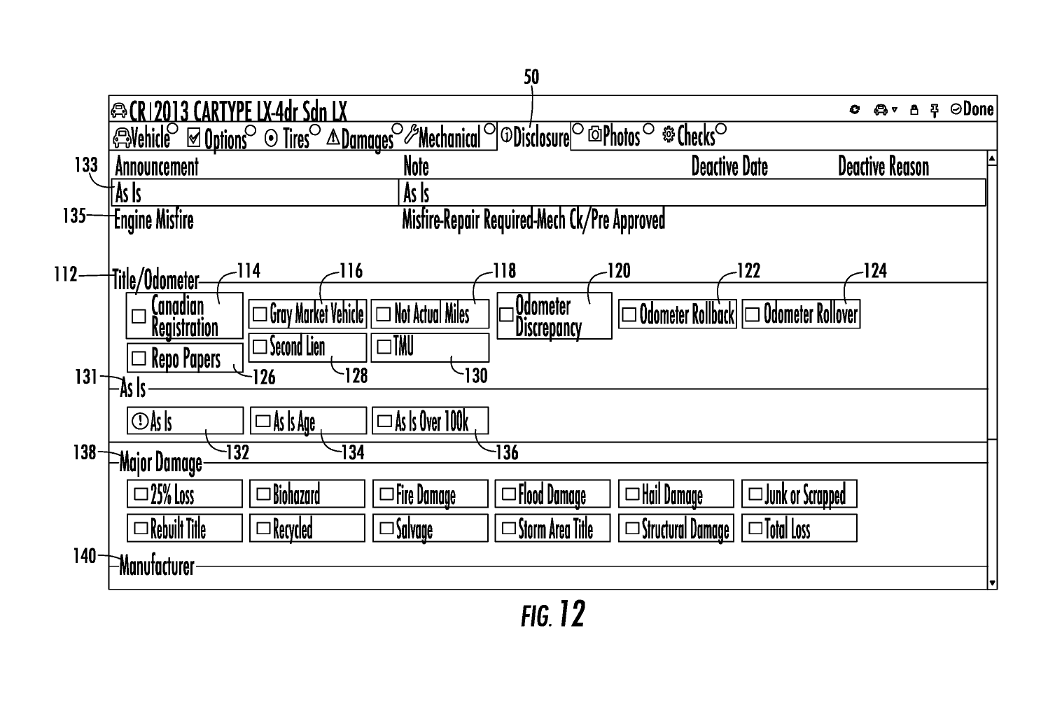

FIG. 13 illustrates a checkpoint component feature, “Checks” Tab 54, to be used by an inspector in generating a vehicle condition report 12. A checkpoint component is technically similar to disclosures, differing in that it is used to perform an action or a review of an item, as well as the added functionality of pre-built responses for the cases where the checkpoint is not satisfied. As illustrated, a “GPS Removed” checkpoint 144 could have options “Could Not Locate” 146 and “No GPS” 148 to use instead of just leaving the box unchecked; it provides a reason the checkpoint is not completed.

In FIG. 13, “GPS Removed” checkpoint 144 has been opened, showing the pre-built response options as a drop-down. If the inspector is able to remove the GPS, the inspector will press the check box 145. If the inspector is unable to remove the GPS, the inspector can select the “Could Not Locate” 146 or “No GPS” 148 option to indicate a problem with removing the GPS. Only one checkpoint group called “Checkpoints” 150 is shown. However, many, unique checkpoints can be illustrated and grouped accordingly with simple table configurations. The response to the checkpoint could auto-generate an Estimate Request similar to FIG. 10A, a Work Order similar to FIG. 7A, and/or a Transport/Driver Request similar to FIGS. 7B and 10B, to transport the vehicle or schedule logistics for the vehicle to a corresponding vendor or lot, initiate, schedule or automate other workflow, or be used to make optimized decisions or to make optimized decision recommendations. The checkpoints, their selections and the subsequent physical action(s) can all be configured uniquely or determined by editing rows in a table for the following, including, but not limited to, each user's or seller's business rules, seller type or by any vehicle type, condition data, any vehicle attribute or vehicle specific data, or combinations thereof.

The screen shot also provides a question group 152 with a question component 154. The question component 154 provides a mechanism to present a custom question, or questions, to the inspector. If there are multiple questions, these questions can be grouped together with similar subject matter. When the question component 154 is clicked, a prompt will appear with the question for the inspector to answer. Once the question is answered, a checkmark placed in box 156 indicates completion. For example, the seller could configure the application to ask the following question when one or more seats have “Stains-Permanent-Dyeing”: “Do you think the stains on the seats will come out with an extra cleaning?” The answer to the question could auto-generate an Estimate Request, an approved Work Order and/or a Transport/Driver Request to transport the vehicle and/or schedule logistics for the vehicle to a corresponding vendor or lot, initiate, schedule or automate other workflow, or be used to make optimized decisions or to make optimized decision recommendations. The questions, their answers and the subsequent physical action(s) generated can all be uniquely configured or determined by editing rows in a table for the following, including but not limited to, each user, seller or seller type or by any vehicle type, condition data, any vehicle attribute or vehicle specific data, or combinations thereof.

Condition report filters and triggers may be utilized in creating the vehicle condition report 12 to allow for the disabling or hiding of any component within the vehicle condition report 12. If a particular component is assigned a filter, that component will only be enabled if that filter gets applied to the condition report. As an illustrative example, a certain checkpoint may be desired only for vehicles older than 2010. Vehicles with a year before 2010 will get assigned the filter, and any component linked to that filter will automatically enable. The filter is used to do the enabling, while the trigger turns on a filter. A component is linked to a specific filter and only enabled if that filter is applied to the vehicle condition report 12. A filter can be defined to match a Disclosure, an Option, a Damage type, a Damage area, a Severity, Note, Remedy or Action, or any other vehicle, seller, vehicle type, condition data or any other vehicle attribute, or combinations thereof. Clicking the Disclosure or some other data captured during the inspection, or via data integration, will trigger the filter to become active. Any component that has been linked to that filter will then become enabled.

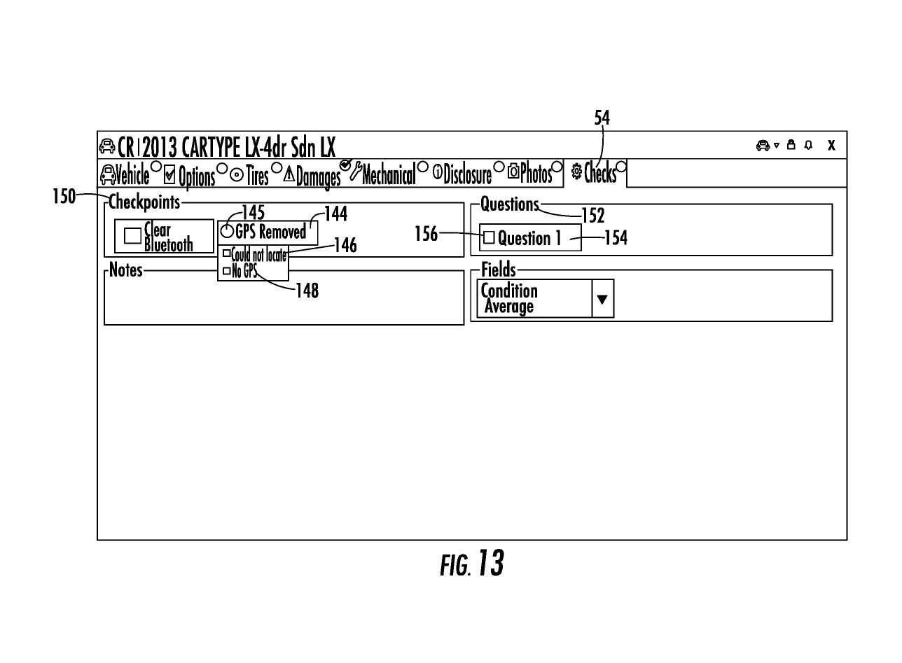

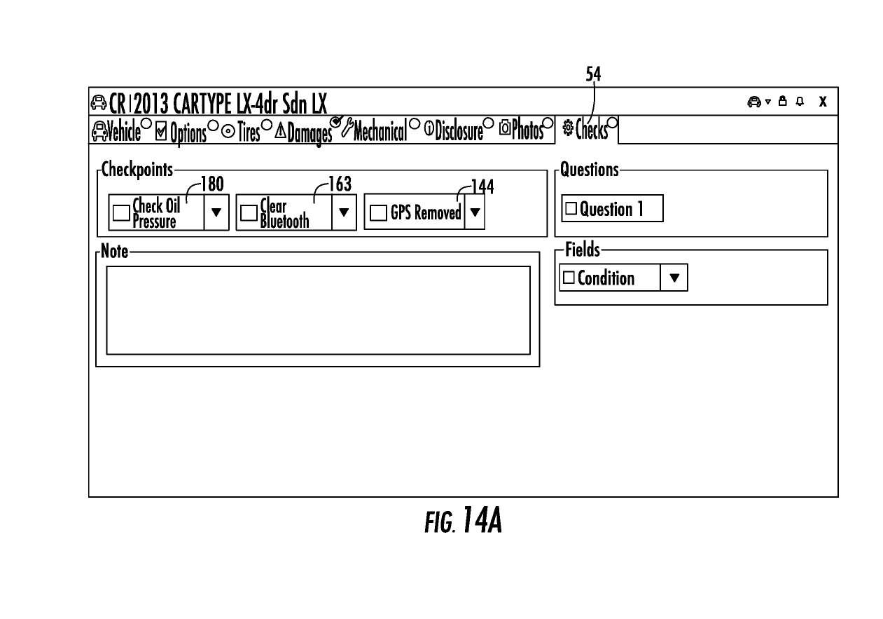

A filter can be applied to any component on the vehicle condition report 12. The filter can either hide or disable a component. While a filter can be applied to any component, it is most useful when it comes to checkpoints and questions. It allows for vehicle specific checkpoints and questions relating to a specific make, model, age range of the vehicle, engine model, transmission type, or combination of these or other vehicle attributes. For example, in FIG. 14B, if 2007-2011 model year Chevrolet Suburbans with 5.3 L engines commonly have issues with their oil pressure, the filters and triggers allow for a custom checkpoint titled “Check Oil Pressure” 180 to appear for all 2007-2011 model year Suburbans that have a 5.3 L engine. The example is for a 2009 Chevrolet Suburban with a 5.3 L engine. Because the vehicle is between the years 2007 and 2011, is a Suburban and has a 5.3 L engine, the “Check Oil Pressure” checkpoint 180 becomes enabled.

The inspector has the option to check mark the “Check Oil Pressure” checkpoint 180 by pressing on the empty box 180A, which marks the Oil Pressure as checked and okay; or the inspector could check mark “Oil Pressure Low” 180B or “Unable to Check” 180C. If the inspector marks “Oil Pressure Low” 180B, the seller or auction could have a Transport Request, similar to FIG. 10B, auto-generated and an Estimate Request, similar to FIG. 10A, auto-generated and have the vehicle moved to the mechanic shop; or auto-generate a specific Workflow Request to further diagnose or remedy the issue, as well as cancel a Workflow that was pre-determined because of the mechanical issue, (i.e. if the vehicle was pre-set to be detailed, it could cancel the detail and be updated to have a minor wash and vacuum instead). Filters and triggers will enable an auction to avoid arbitrations by guiding inspectors to look for issues common across different vehicles and their equipment. They will also enable dealerships to guide their trade-in appraisers to avoid making costly mistakes when purchasing a vehicle on trade.

FIG. 14A illustrates the “Clear Bluetooth” 163 checkpoint being disabled because it is set to only display if the Bluetooth filter is applied. The Bluetooth filter will only get applied if the “Bluetooth” 60 option, see FIG. 2, is checked on the “Options” tab 42. FIG. 14A displays a different vehicle than what was used on FIG. 2, so Bluetooth was not enabled for the vehicle used in FIG. 14A. When the “Bluetooth” 60 option is checked, it triggers the Bluetooth filter to become active, and all components with that filter will become enabled. The Bluetooth checkpoint would become enabled if the inspector selected the “Bluetooth” option 60 on the “Options” tab 42, and the inspector would have the option to mark the Bluetooth content as cleared, unable to delete, or as invalid. If the inspector marks the Bluetooth checkpoint as unable to delete, the seller could have pre-configured the vehicle to be transported to the mechanic to ensure the task of clearing the Bluetooth content is completed as displayed. By applying any filter, multiple components, checkpoints or questions could become enabled, initiating a single or multi-step workflow. For example, with personally identifiable information becoming an important compliance issue for banks and dealers, it is important for their staff and their hired inspectors to know which vehicles have Bluetooth, in order to clear any personally identifiable information or content that may have been synchronized with the vehicle's information system via Bluetooth inside these high-tech vehicles. Similarly, “GPS Removed” 144 is active if the GPS filter has been enabled. This filter has been triggered by a field selection on a prior vehicle assignment tab, or it was stored in historical vehicle data. In this example, checkpoint fields that are not allowed are disabled as indicated by the lighter gray shading, but they could just as easily be completely hidden.

The commercial goods reporting system and methods 10 is preferably configured to generate corresponding seller or third party vendors 162 (see FIG. 1) reconditioning or mechanical Work Orders, Estimate Requests, Transport Orders, notifications and other automated workflow and logistics scheduling via a communication network for any damage line item created in the vehicle condition report 12, defined herein as “scheduled and/or automated workflow”. Referring back to FIG. 1, all data is saved locally and to the mobile computing device 32, or to the general computing device 18 and to the Web Server/Main Server System 30 dynamically at the moment it is captured. If the condition report 12 is captured in offline mode, all data will be saved locally on the mobile computing device without access to the internet. Once the mobile computing device 32 accesses the internet, the condition report will be saved to the Web Server/Main Server System 30. Once a damage line item has been captured, the scheduled and/or automated workflow is initiated, but not sent until the condition report 12 is completed. Once the condition report is completed and/or the scheduled workflow date and time has arrived, the workflow begins or the request and notification are sent using, for example, phone communication, internet or cloud based communication 164, and the requests can be sent from the Main Server System 30, or directly from the mobile or general computing devices 32. If a similar damage line item is subsequently captured, the request will be updated to include the new damage line item, as long as the seller's, inspection company's, or user's business rules permit. A network security system, such as a firewall 165, may be used to monitor and control incoming and outgoing network traffic based on predetermined security rules. Once a damage line item has been generated, notifications such as through emails, texts, fax, flagging, triggers, messaging or other communication methods, for an Estimate Request, recommendation or an actual repair Work Order, Transportation Order, or other automated workflow can be generated or scheduled, or put into the decision engine to be optimized. Such Estimate Requests, recommendations, Work Orders or workflow can be generated or scheduled based on pre-determined seller or user business rules, the condition data, pricing and any vehicle or other market data that may affect what is optimal for any particular vehicle based on the owner's objectives and goals with each vehicle or groups of vehicles.

Activating a one-click or two-click button or multi-part, similar damage button to create damage line item(s) which contain a Part, the Damage, the Severity and/or a Remedy or action may generate or schedule a corresponding repair Work Order or repair Estimate Request, a key request, a Transport Order, and any other workflow processes, whether online or in the physical world. Such requests are then sent to the vehicle owner and/or to the corresponding vendor performing the repair, as well as an outside coordinator, transport company, driver or any other stakeholders. The vehicle may be driven or shipped to a pre-determined vendor or auction/lot shop based on the vehicle owner's preferences; or the vendor may be directed to the vehicle's current location to perform work on the vehicle without moving the vehicle.

Additional features of the commercial goods reporting system and methods 10 may include the use of voice recognition or activation to document all of the details of the vehicle, whether or not the parts function or operate, and the ability to capture damage line items, along with photos and/or videos, for any area of the vehicle, including but not limited to, options, equipment, accessories, interior, exterior, body, glass, trim, mechanical, wheels, tires, frame, unibody or structural. The inspector may choose to document the condition report 12 with his/her voice, instead of by clicking or pressing on the buttons on the interface.

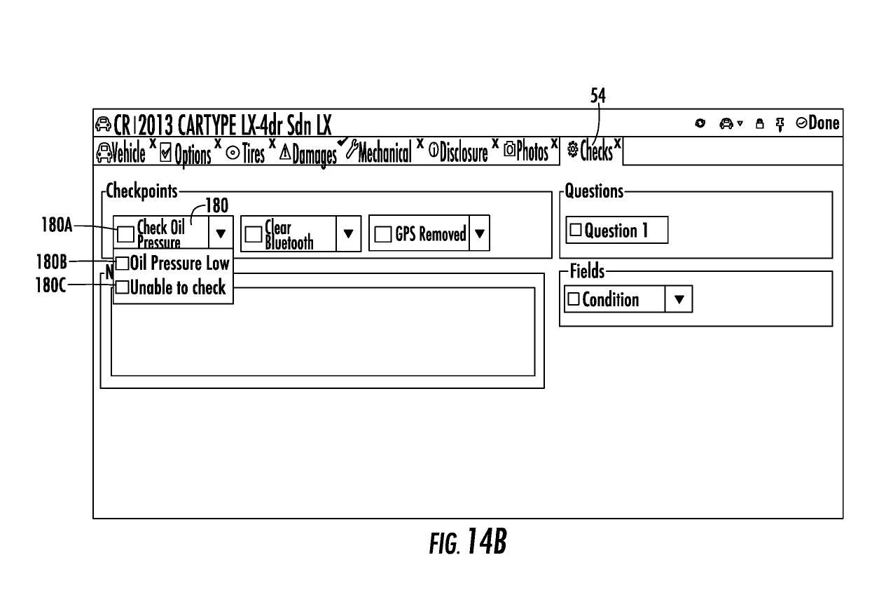

As displayed in FIG. 1A and FIG. 15, additional features of the commercial goods reporting system and methods 10 may include the use of a paint coating thickness meter 37 to gauge the thickness of the paint coatings in order to determine whether or not an exterior body panel has been painted after the manufacturer painted the vehicle. The user has the option to capture one or two paint coating meter readings per panel selected, see Reading 1 or Reading 2 columns 190 and 191. The user has the option to select each panel on a vehicle image prior to each reading, or the user can select the LF Fender 188 as their starting point, record its paint meter reading 190A with the paint meter (not shown), and then sequentially record each subsequent panel's paint meter reading without touching the device until the last panel is recorded on the body of the vehicle. As each reading is recorded and the next panel is ready to be metered, the panel on the vehicle ready to be metered becomes highlighted. In this case, the deck lid 187 is highlighted and ready to be metered. Each panel's paint coating thickness measurement is automatically sent to the mobile computing device 32 via Bluetooth or other future connectivity capabilities enabled by the paint meter manufacturers. In FIG. 15, the LF Door 189 has been previously repaired based on the paint meter readings 190B and 191B, signified by the “paint brush” icon 189A, and the application will auto-generate a damage line item “Part-LF Door”; “Damage-Prev Repair”; “Severity-Acceptable”; “Remedy-No Action Required” (not shown). The user can change the Severity and Remedy in the Exterior Damage Line Item Selector 169, see FIG. 11D, Severity 93, and FIG. 11E, Remedy 95, with two button presses if the paint repair is deemed to be substandard, or the application can be configured to edit the severity of the previous repair right from the paint meter reading page on FIG. 15.

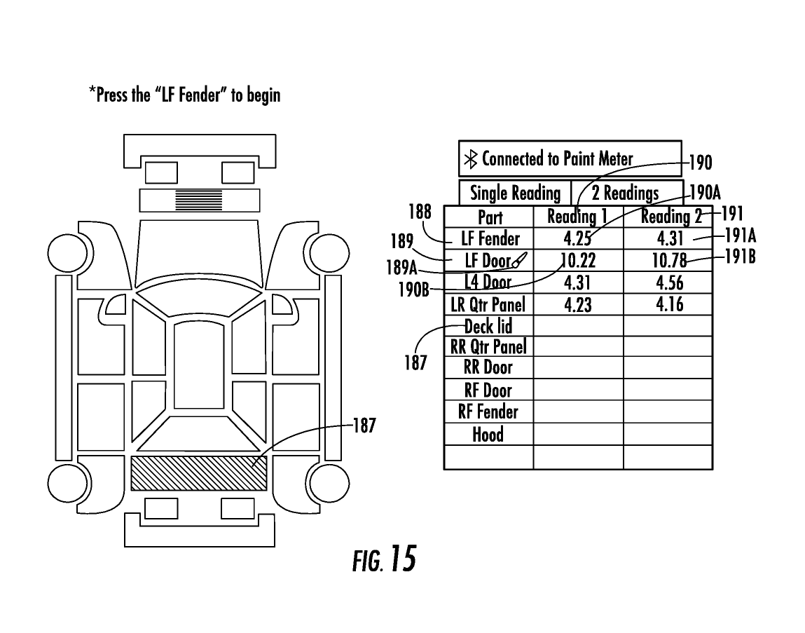

Additionally, an OBD2 (On-board Diagnostics) scanner device 33 (See FIG. 1 and FIG. 16) can be used to access a vehicle's various subsystems by plugging the device into a standardized digital communications port to access real-time data and a standardized series of diagnostic trouble codes (DTCs) 192, enabling the inspector to record and identify mechanical malfunctions and recommend possible remedies to the identified malfunctions in the vehicle. The DTCs 192 can be transferred to the mobile computing device 32 via Bluetooth or other future connectivity capabilities. The DTCs 192 can be mapped to diagnostics database tools, providing the users with more accurate diagnostics and probable remedies. FIG. 16 displays the results from an OBD2 scan transferred to the application. The first column displays the scanned DTC (diagnostic trouble code) 192, the second column is a description 193 of the DTC 192, the third column is a possible Remedy 194, and the fourth column is a note 195. In this case, the DTC is “P0139” 192A, the description is “O2 Sensor Circuit Slow Response Bank 1/Sensor 2” 193A, the Remedy is “Replace O2 sensor” 194A, and the Note 195A is blank.

Additionally, a professional camera 35, see FIG. 1, can be used to take enhanced images, 360 degree images, and/or augmented or virtual reality imaging of the vehicle and upload the images to the Mobile Computing Device 32 via Bluetooth, a cable or WiFi or cellular connectivity, or directly to the Web Server/Main Server System 30.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for inspecting, documenting, reporting, or rating of a commercial good, comprising:
an electronic commercial goods condition report having one or more information components which document a condition of a commercial good;
at least one electronic device having a screen for displaying images, a processor operable to execute instructions and a data storage medium for storing instructions, which, when executed by said processor, cause said processor to display said changeable electronic commercial goods condition report having one or more information components which documents a condition of a commercial good; and
at least one data source operatively connected to said at least one electronic device.

2. The system for inspecting, documenting, reporting, or rating of a commercial good according to claim 1 wherein said electronic document is a condition report having data which provides a user an assessment as to the condition of said commercial good based on one or more parameters.

3. The system for inspecting, documenting, reporting, or rating of a commercial good according to claim 2 wherein said commercial good is a vehicle.

4. The system for inspecting, documenting, reporting, or rating of a commercial good according to claim 3 wherein said condition report includes one or more damage line items.

5. The system for inspecting, documenting, reporting, or rating of a commercial good according to claim 4 wherein said condition report includes a work order, said work order having at least one vehicle requirement that requires an action.

6. The system for inspecting, documenting, reporting, or rating of a commercial good according to claim 5 wherein said work order is electronically connected to a third party which can perform at least one vehicle requirement that requires an action.

7. The system for inspecting, documenting, reporting, or rating of a commercial good according to claim 1 wherein said at least one data source comprises data relating to VIN decoding data, repair data for parts and labor estimating, wholesale, aftermarket and used parts repair data pricing, and vehicle rating data.

8. The system for inspecting, documenting, reporting, or rating of a commercial good according to claim 1 further including a camera.

9. The system for inspecting, documenting, reporting, or rating of a commercial good according to claim 1 further including a paint meter.

10. The system for inspecting, documenting, reporting, or rating of a commercial good according to claim 1 further including a secondary electronic device.

11. The system for inspecting, documenting, reporting, or rating of a commercial good according to claim 10 wherein said secondary electronic device is a smart phone or tablet computer.

12. The system for inspecting, documenting, reporting, or rating of a commercial good according to claim 4 wherein said vehicle condition report uses a table configurable interface having one or more tabs covering multiple areas or characteristic of said vehicle.

13. The system for inspecting, documenting, reporting, or rating of a commercial good according to claim 4 wherein said one or more damage line items are linked to generating a request to transport or schedule logistics for said vehicle to a predetermined vendor.

14. The system for inspecting, documenting, reporting, or rating of a commercial good according to claim 4, wherein a photo or video of said vehicle is linked to said damage line item.

15. A method for inspecting, documenting, reporting, or rating of a commercial good comprising:
using at least one electronic device for generating an electronic commercial goods condition report having one or more information components which documents a condition of a commercial good, said at least one electronic device having a screen for displaying images, a processor operable to execute instructions and a data storage medium for storing instructions, which, when executed by said processor, cause said processor to display an electronic commercial goods condition report having information which documents a condition of said commercial good;
using at least one data source operatively connected to said at least one electronic device to provide data which forms at least a part of said electronic commercial goods condition report information.

16. The method for inspecting, documenting, reporting, or rating of a commercial good according to claim 15 wherein said commercial good to be inspected, documented, reported, or rated is a vehicle.

17. The method for inspecting, documenting, reporting, or rating of a commercial good according to claim 16, further including the creation of a damage line list.

18. The method for inspecting, documenting, reporting, or rating of a commercial good according to claim 16, further including the use of a vehicle tab component configured to allow a user to note the inclusion or condition of one or more of the vehicle attributes relating to an interior portion, mechanical component, an exterior portion of said vehicle, and an options tab to guide said user through options that are contained in said vehicle to generate said electronic vehicle condition report.

19. The method for inspecting, documenting, reporting, or rating of a commercial good according to claim 16, further including generating a work order having at least one vehicle requirement that requires an action.

20. The method for inspecting, documenting, reporting, or rating of a commercial good according to claim 16, further including linking a photo or video of said vehicle to a damage line item.
